(19) United States
(12) Patent Application Publication
(10) Pub. No.: US 2023/0124326 A1
(43) Pub. Date: Apr. 20, 2023

(54) LIFTING DEVICE

(71) Applicant: Frendix USA LLC, Beachwood, OH (US)

(72) Inventors: William B. Pappas, Beachwood, OH (US); Alan D. Alford, Beachwood, OH (US)

(21) Appl. No.: 17/959,805

(22) Filed: Oct. 4, 2022

Related U.S. Application Data
(60) Provisional application No. 63/252,460, filed on Oct. 5, 2021.

(51) Int. Cl. B66F 9/12; B66F 9/075

(52) U.S. Cl. CPC B66F 9/12; B66F 9/07563; B66F 9/07504; B66F 2700/09

(57) ABSTRACT

Improved lifting devices typically configured to move heavy loads to and from the cargo area or bed of an associated vehicle are disclosed.

The present disclosure claims priority on U.S. Provisional Application Ser. No. 63/252,460 filed Oct. 5, 2021, which is incorporated herein by reference.

The present exemplary embodiments relate to improved lifting devices configured to move heavy loads to and from the cargo area or bed of an associated vehicle. However, it is to be appreciated that the present exemplary embodiments are also amenable to other like applications.

### BACKGROUND

Transportable loads often have to be lifted to and from the raised platforms of vehicles which transport the loads. The moving of the load to the desired loading space is carried out by means of different forklift trucks or other known machines. However, smaller and smaller delivery vehicles are being used to transport these loads, even though it is often desirable for said lifting devices to be substantially maneuverable inside the vehicle.

It is desirable to provide a lifting device which meets the aforementioned needs.

### SUMMARY OF DISCLOSURE

An improved lifting devices configured to move heavy loads to and from the cargo area or bed of an associated vehicle. The improved lifting device is optionally configured to be foldable to reduce its size during storage and/or transport. The improved lifting device is optionally configured to a) lift itself into and out of a carbo bay of a trailer, b) onto and off a deck of a truck, c) onto and/or off a surface that is located at one plane of elevation to another surface that has a different plane of elevation, d) move objects from one plane of elevation to another surface that has a different plane of elevation, and/or e) lift objects and then move the lifted object to another location and then lower the object at the other location.

The improved lifting device includes a comprises a main body, a lift housing that is connected to the main body, a fork structure that is movable a long at least a portion of the longitudinal length of the lift housing, and retractable support arms that include wheels that are connected to the main body and/or lift housing. The main body optionally includes two or more roller or wheels to facilitate in the moving of the main housing over a surface (e.g., floor, cargo bay, truck bed, etc.). Generally, the two or more rollers or wheels are located below a top surface of the main housing; however, this is not required. The fork structure is optionally foldable and/or pivotable on the lift housing between a folded storable position to an unfolded operational position. When the fork structure is in the folded storable position, the longitudinal axis of the fork structure is oriented ±0-15° (and all values and ranges therebetween) to a plane that is parallel to the front face plane of the lift housing. When the fork structure is in the unfolded operational position, the longitudinal axis of the fork structure is oriented ±0-15° (and all values and ranges therebetween) to a plane that is perpendicular to the front face plane of the lift housing. The fork structure optionally includes two arms that are positioned generally parallel to one another. The fork structure can optionally include one or more rollers or wheels to wheels to facilitate in the moving of the fork structure over a surface (e.g., floor, cargo bay, truck bed, etc.) when the fork structure is in the unfolded operational position. Generally, the two or more rollers wheels are located below a top surface of each of the arms of the fork structure; however, this is not required. The retractable support arms are optionally configured to move between a retract stored position and a nonretracted support position. Each of the retractable support arms are optionally rotatably or pivotally connected to the main body and/or lift housing. When the retractable support arms are in the retract stored position, the one or more roller or wheels on each of the retractable support arms are elevated off of a surface (e.g., floor, cargo bay, truck bed, etc.) and each of the retractable support arms are moved in closer alignment with the lift housing to create a smaller profile of the improved lifting device for storage. When the retractable support arms are in the nonretracted support position, the one or more roller or wheels on each of the retractable support arms are in contact with a surface (e.g., floor, cargo bay, truck bed, etc.) so as to provide support to the improved lifting device and to inhibit or prevent the tipping of the improved lifting device when a load is lifted by the fork structure. The retractable support arms can optionally be rotated about multiple axis during movement of the retractable support arms between the retracted stored position and the nonretracted support position. Such multiple rotational axis movement can be used to facilitate in the profile reduction of the improved lifting device when the retractable support arms are in the retracted stored position. The one or more roller or wheels on each of the retractable support arms can be pivotally or rotatably mounted so that the one or more roller or wheel can both roll and swivel relative to the each of the retractable support arms. Suck a configuration facilitates in the turning of the improved lifting device when the retractable support arms are in the nonretracted support position.

### BRIEF DESCRIPTION OF THE DRAWINGS

Reference may now be made to the drawings, which illustrate various embodiments that the disclosure may take in physical form and in certain parts and arrangement of parts wherein:

FIGS. 1A and 1B are illustrations according to one non-limiting embodiment of the present disclosure which show a perspective front view of an improved lifting device;

FIGS. 2A and 2B show a perspective rear view of the improved lifting device of FIGS. 1A and 1B;

FIGS. 3A and 3B show a side view of the improved lifting device of FIGS. 1A and 1B;

FIG. 4A shows a rear view and FIG. 4B shows a top view of the improved lifting device of FIGS. 1A and 1B;

FIG. 5 shows a side view of the improved lifting device of FIGS. 1A and 1B, but with a carriage and forks raised up above the height of a cargo area or bed of an associated vehicle (not shown);

FIG. 6 shows a side view of the improved lifting device of FIGS. 1A and 1B, but with the carriage and forks lowered down to the height of a cargo area or bed of the associated vehicle (not shown);

FIGS. 7A, 7B, and 7C are illustrations according to another non-limiting embodiment of the present disclosure which show perspective views of an improved lifting device;

FIGS. 8A and 8B show a perspective rear view of the improved lifting device of FIGS. 1A and 1B;

FIG. 9 shows an exploded assembly view of the improved lifting device of FIGS. 1A and 1B;

FIGS. 10-15 show a perspective rear view of another non-limiting embodiment of the improved lifting device;

FIGS. 16-19 show a perspective front and rear perspective views of another non-limiting embodiment of the improved lifting device;

FIGS. 20-25 show one non-limiting operation of the improved lifting device for the loading and unloading of materials into a trailer of a truck;

FIGS. 26-39 show one non-limiting device for the storing of the improved lifting device at the rear portion of a truck cab;

FIG. 40 shows the improved lifting device can be stored at the rear portion of a truck cab;

FIG. 41 shows the improved lifting device can be stored at the front of a truck cab;

FIGS. 42-44 show the improved lifting device can be stored at the rear of a trailer of a truck;

FIGS. 45 and 46 show non-limiting dimension and parameters of the improved lifting device; and,

FIGS. 47-58 illustrate another non-limiting embodiment of the improved lifting device.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

These and other advantages will become apparent to those skilled in the art upon the reading and following of this description.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

To aid the Patent Office and any readers of this application and any resulting patent in interpreting the claims appended hereto, Applicant does not intend any of the appended claims or claim elements to invoke 35 U.S.C. 112(f) unless the words “means for” or “step for” are explicitly used in the particular claim.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the certain embodiments. These and other modifications of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

Referring now to the drawings, wherein the showings are for the purpose of illustrating non-limiting embodiments of the disclosure only and not for the purpose of limiting the same.

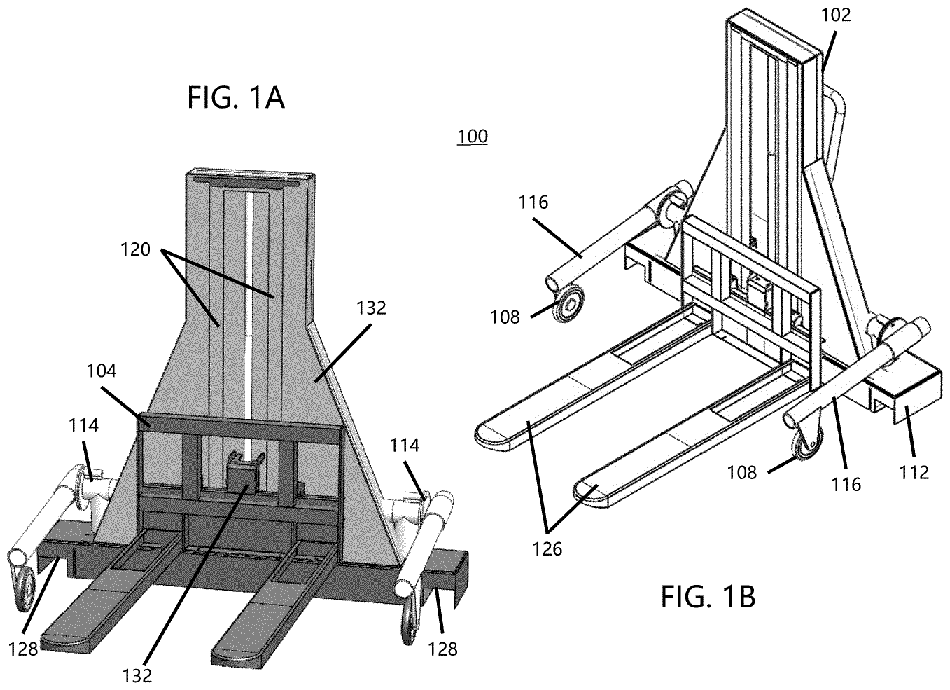

A first non-limiting embodiment of a lifting device 100 according to the present disclosure is illustrated in FIGS. 1A-1B, 2A-2B, 3A-3B, 4A-4B, 5, and 6. The lifting device 100 is formed primarily of an upright body 102 and a carriage 104 with one or more forks 126. The body 102 and carriage 104 are generally manufactured of appropriate steel profiles and plate elements by welding; however, such an embodiment is non-limiting.

A powered lifting mechanism 106 is adapted to guidedly adjust the vertical position of the carriage 104 with respect to the body 102, thereby raising or lowering a load (not shown) supported on the forks 126. The vertical movement of the carrier 104 by the lifting mechanism 106 is controlled and supported by one or more stanchions 120. A beam 112 is included which provides stability and support for the various other components of the lifting device 100, including the stanchions 120. Generally, the beam 112 is oriented perpendicular to the upright body portion 102 and stanchions 120. However, such configuration is non-limiting.

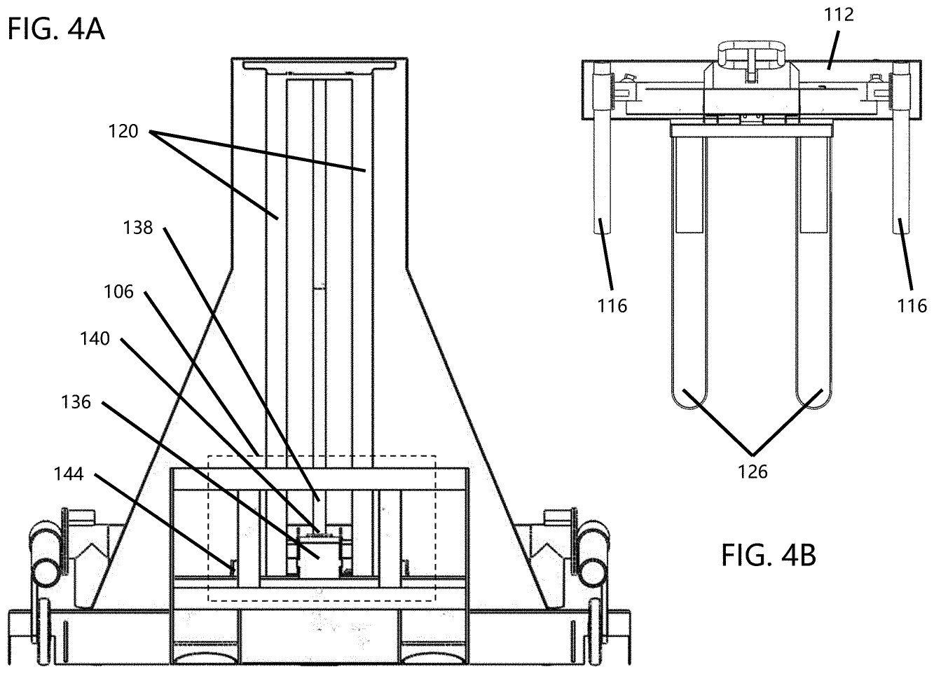

As best seen in FIG. 4A, the lifting mechanism 106 of the lifting device 100 utilizes a nut 140 and threaded screw 138 drive arrangement. Operation of the nut and screw drive 140, 138 is generally provided by an electric motor 136 which is powered by a power source, such as batteries 144. An electrical switch control 107 can be used to activate and deactivate the lifting mechanism 106 and/or to cause the carrier 104 to move upward or downward. As can be appreciated, other or additional arrangements can be used to activate and/or deactivate the lifting mechanism 106 and/or to cause the carrier 104 to move upward or downward (e.g., movable jack handle, app on a smart device, program on a tablet or computer, voice controls, control panel, etc.).

More particularly, the nut and screw drive 140, 138 is configured to guidedly adjust, with respect to the body 102, the vertical position of the carriage 104, forks 126, and any load supported thereon. In this manner, the drive nut 140 is connected to the carriage 104 and is driven by electric motor 136. When a user activates the activation/control arrangement (e.g., the jack handle 134 in an upward or downward fashion or uses the electrical switch 107), the electric motor 136 engages the drive nut 140, causing it to spin and climb its way up or down the threaded screw 138. The carriage 104, forks 126, and any load supported thereon are thus caused to move linearly up and down as the drive nut 140 spins on the threaded screw 138. Likewise, when the carriage 104 and forks 126 are supported by an external element, such as the platform of a vehicle (not shown), the nut and screw drive 140, 138 is configured to guidedly adjust the vertical position of the body 102 with respect to the carriage 104 and forks 126.

Use of the nut and screw 140, 138 drive arrangement provides many advantages to the exemplary lifting mechanism 100. For example, the drive arrangement which includes just the drive nut 140 and threaded screw 138 is a simple design which results in easy maintenance and service. Moreover, since this drive arrangement has few parts, the lifting mechanism 100 can retain a small footprint. Any enclosure or housing (e.g., enclosure 132 and motor housing 142) protecting the components of the lifting mechanism 100 can thus also retain a small footprint. As a result, the lifting mechanism 100 of the present disclosure is ideal for small spaces, such as the cargo area of small vans or trucks, and can be easily navigated around potential obstructions within such spaces, such as vehicle wheel housings.

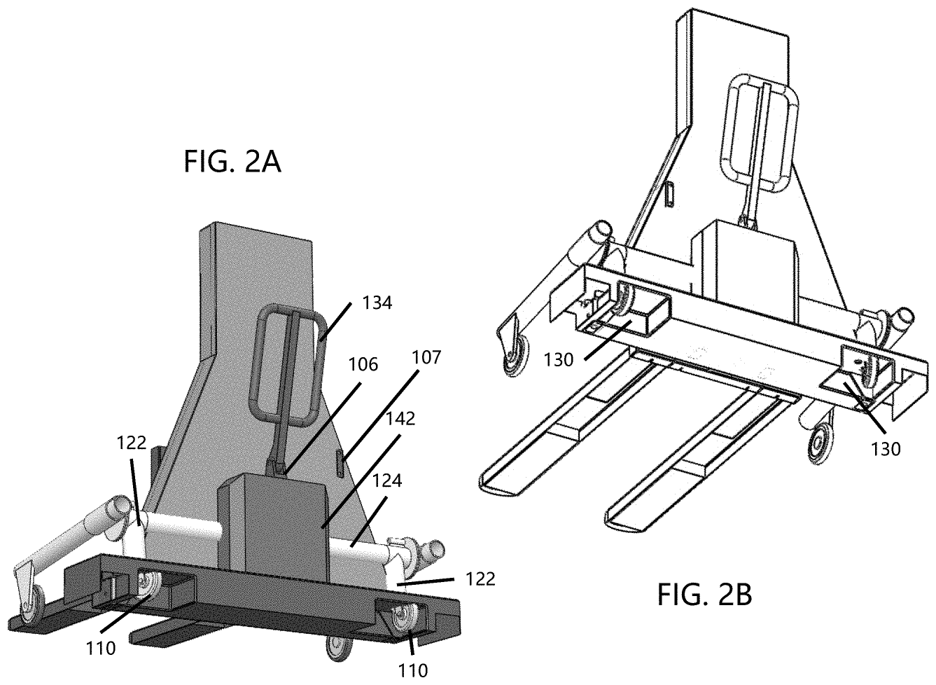

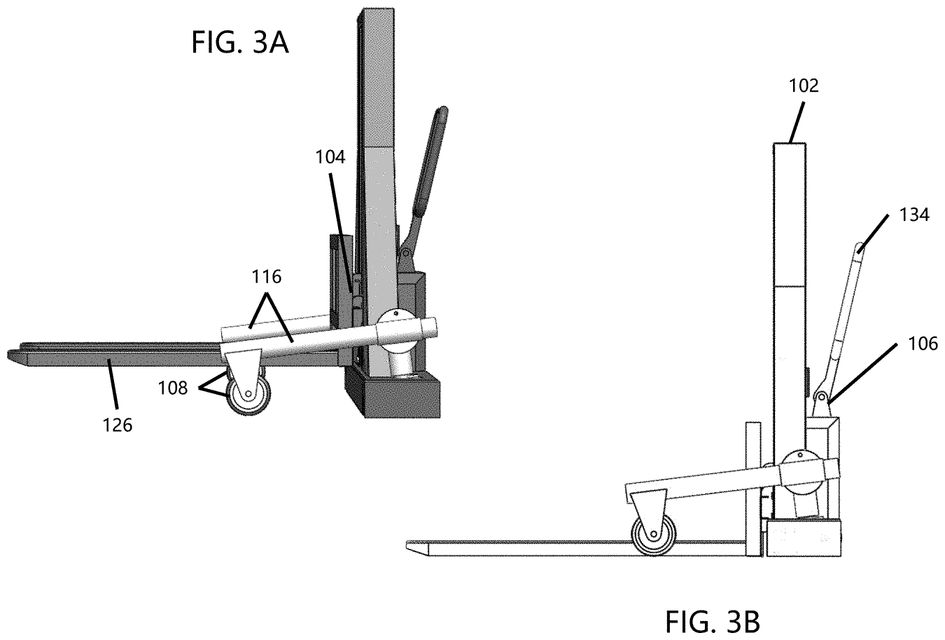

The small footprint of the presently disclosed lifting mechanism 100 is also maintained by the design of the one or more sets of wheels or rollers 108 and 110. The wheels or rollers 108 and 110 enable planar movement of the body 102 and carriage 104 with respect to the floor and in a controlled manner. In general, the lower surface of the wheels or rollers 108, 110 lies appropriately below the other constructional elements of the lifting device 100 of the present disclosure. Moreover, one of the pair of wheels or rollers 108, 110 is typically of a free-rotating construction (i.e., non-direction-bound) which permits steering of the lifting device 100. The other pair of wheels is typically a fixed construction (i.e., direction-bound) which does not allow for steering. As illustrated in FIGS. 2A and 3A, wheels or rollers 108 are of the fixed type and wheels 110 have a free-rotating construction. However, such a configuration is non-limiting.

A pair of arms 116 is disposed on both sides of the body 102. The first set of wheels or rollers 108 is attached to one end of the arms 116. The other end of arms 116 is attached to the body 102 via rotating connector element 114. The rotating connectors 114 permit each arm 116 and wheels or rollers 108 to be oriented and locked into position with respect to the carriage 104 and forks 126. For example, the arms 116 and wheels or rollers 108, 110 are positioned generally parallel to and underneath forks 126 whenever the lifting device 100 is supporting a load. In other words, as illustrated in FIGS. 1A-1B, 2A-2B, 3A-3B, 4A-4B, and 5, each of the arms 116 and attached wheels or rollers 108 are positioned and locked into place underneath the forks 126 and associated load, thereby providing support and stability to the lifting device 100 when it is desired to transfer the load from the forks to another plane of support (not shown).

As best seen in FIGS. 2A and 2B, a pair of fixed legs 122 provide attachment points for the second set of wheels or rollers 110 on each side of the beam 112. The second set of wheels or rollers 110 attach to the end of the legs 122 such that they are located under the top surface of support beam 112 within cutout portions 128 thereof. A horizontal support member or axle 124 disposed above the top surface of the beam 112 connects the other ends of legs 122. In this regard, the legs 122 and axle 124 position the second set of wheels or rollers 110 to provide support near to the plane created by the upright body 102 and stanchions 120. However, such a configuration is non-limiting.

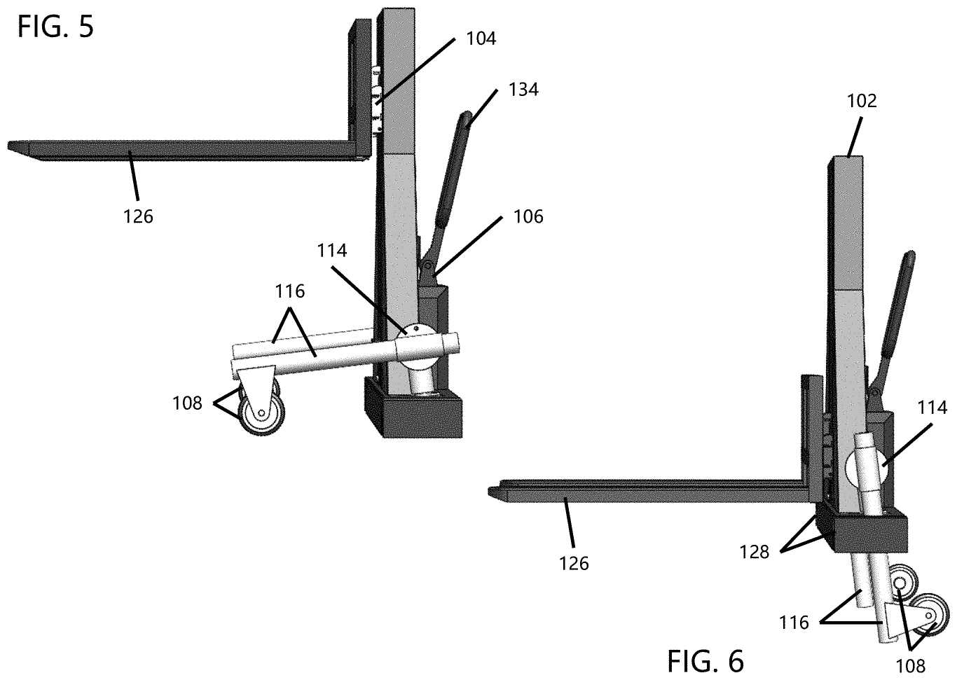

As shown in FIG. 5, the carriage 104 and forks 126 are raised to an appropriate height above the beam 112 for placement of the load onto a platform located above ground, such as onto the bed or cargo space of an associated vehicle (not shown). If the load is already in the bed or cargo area and it is desired to move the load to the ground, the carriage 104 and forks 126 are similarly raised at an appropriate height to be able to engage the load within the vehicle.

Once at the appropriate height, the lifting device 100 is guided mechanically, typically through use of muscular force or an electric motor which drives wheels or rollers 108 or 110, to the proximity of the bed or cargo space of an associated vehicle. The device 100 is pushed toward the vehicle until the carriage 104, forks 126, and load substantially rest on the bed or cargo space of the vehicle. The supporting arms 116 with wheels or rollers 108 bear against the beam 112 and are hereby guided beneath the bed or cargo space of the vehicle. By adjusting the lifting mechanism 106 with the jack handle 134 or electrical switch control 107, the carriage 104, forks 126, and load are lowered until support is borne by the bed or cargo space of the vehicle.

Once the bed or cargo space of the vehicle is providing said support, continued activation of the lifting mechanism (e.g., with jack handle 134) will cause the body 102 and beam 112 to raise off the ground and move upward toward the vehicle. As the body 102 and beam 112 continue to raise off the ground, eventually the rotating connectors 114 permit support arms 116 and wheels or rollers 108 to rotate out from underneath the load. At this point, the support arms 116 and wheels or rollers 108 are locked into the position shown in FIG. 6.

With continued reference to FIG. 6, the rotating connectors 114 thus enable each arm 116 and respective wheels or rollers 108 to be oriented along a plane located generally next to and parallel with a plane defined by the upright body 102 and stanchions 120. In other words, the rotating connectors 114 allow the support arms 116 and wheels or rollers 108 to move out from underneath the forks 126 to a position located generally behind the carriage 104 and underneath beam 112. Notches 128 formed in beam 112 permit the positioning of arms 116 and wheels or rollers 108 in this manner.

Adjustment of the lifting mechanism 106 (e.g., with jack handle 134) is continued such that the body 102 and beam 112 are lifted slightly upward above the plane of the bed or cargo space of the vehicle. In particular, the body 102 and beam 112 are lifted with the drive nut and screw 140, 138 arrangement to a height which permits supporting arms 116 and wheels or rollers 108 to rotate back toward the carriage 104 and forks 126 (i.e., the position illustrated in FIGS. 3A and 3B). At this point, the load can be moved to a desired location on the plane of the bed or cargo space of the vehicle with support of the load again being provided by the carriage 104, forks 106, arms 116 and wheels or rollers 108, 110. The load is then lowered back onto the bed or cargo space of the vehicle at the desired location and the lifting device 100 is pulled out from underneath the load. A loaded or unloaded lifting device 100 according to the present disclosure is removed from the bed or cargo space of the vehicle by taking the above steps in a reverse order.

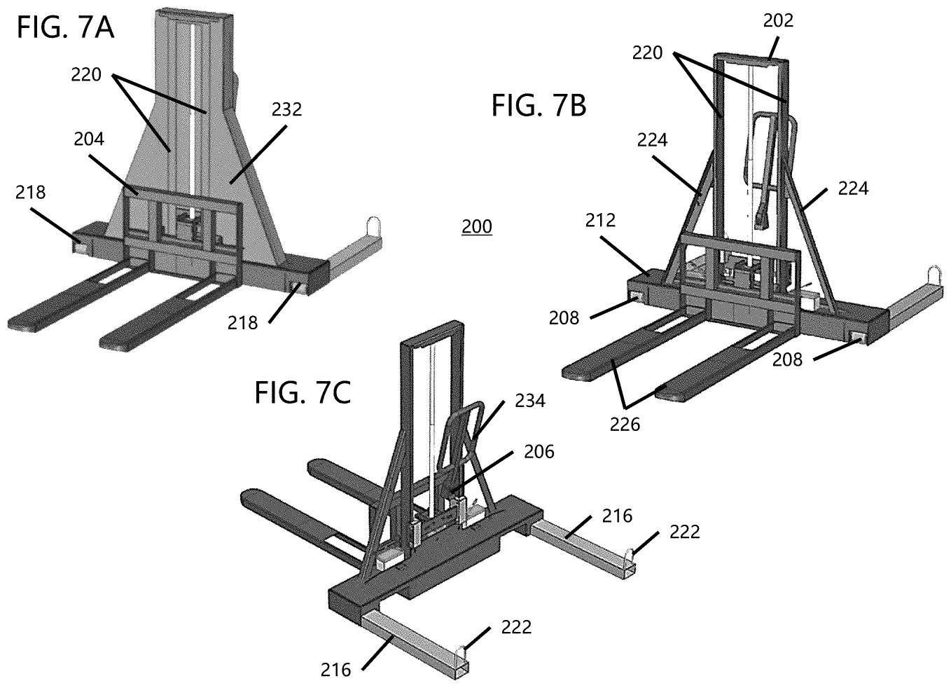

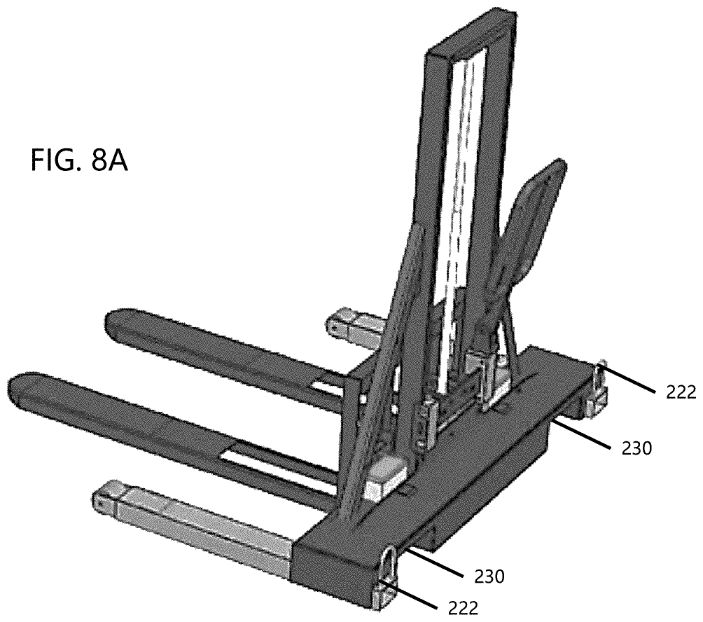

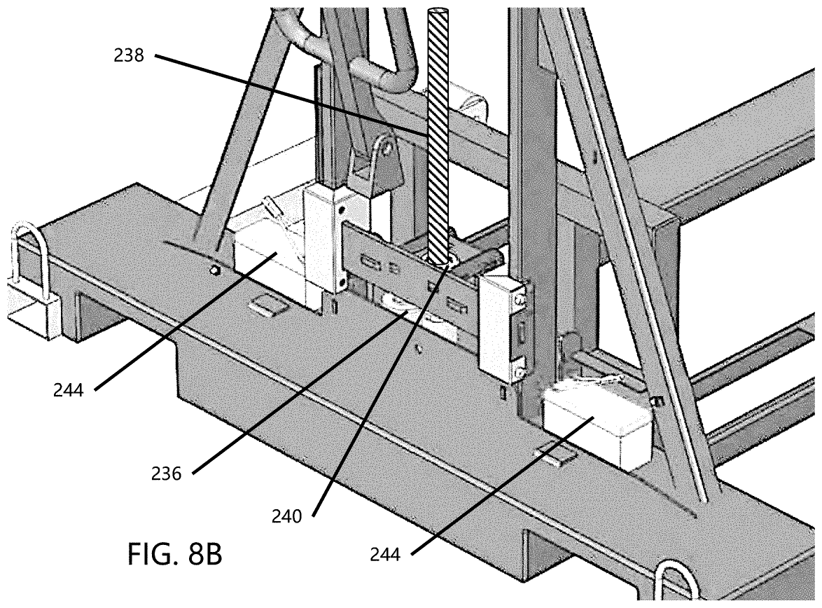

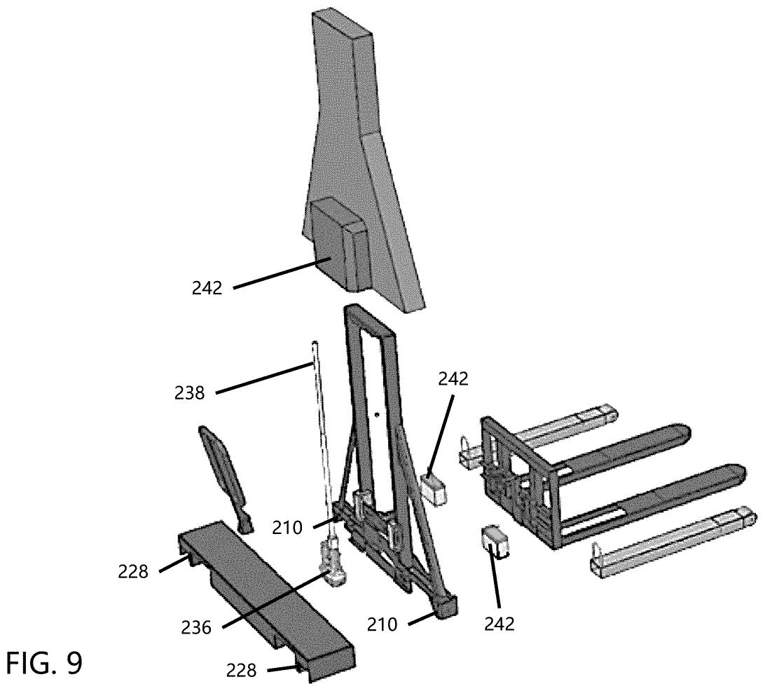

A second non-limiting embodiment of a lifting device 200 according to the present disclosure is illustrated in FIGS. 7A-7C, 8A-8B, and 9. The lifting device 200 is formed of many components which are similar or identical to and operate in substantially the same manner as those described above with respect to lifting device 100. Similar or identical components between devices 200 and 100 include an upright body 202, a carriage 204, a lifting mechanism 206, one or more sets of wheels or rollers 208 and 210, a support beam 212, one or more stanchions 220, forks 226, cutout portions 230 for wheels or rollers 208, an enclosure or housing 232, a jack handle 234, electric motor 236, threaded screw 238, drive nut 240, motor cover 242, and a power source 244.

The lifting device 200 includes some components which are different from lifting device 100. These components include but are not limited to a sliding bar support arm 216 for wheels or rollers 208; a slide element or support track 218 for the support arm; stop walls 222 for the sliding support arm; and sequentially installed bearings within the slide element or support track 218. These elements of lifting device 200 operate as described in patent document EP0533086B1, which is incorporated herein by reference. However, unlike patent document EP0533086B1, lifting device 200 uses a lifting mechanism 206 which operates in the same manner as lifting mechanism 106 of lifting device 100. Also, lifting device 200 uses angled support members 224 to provide additional structural support to stanchions 220 so that a heavier load can be lifted and additional strength and rigidity is created for the stanchions 220 and other structures of the lifting device 200. As illustrated in FIGS. 1-6, a similar structure is also illustrated to provide additional structural support.

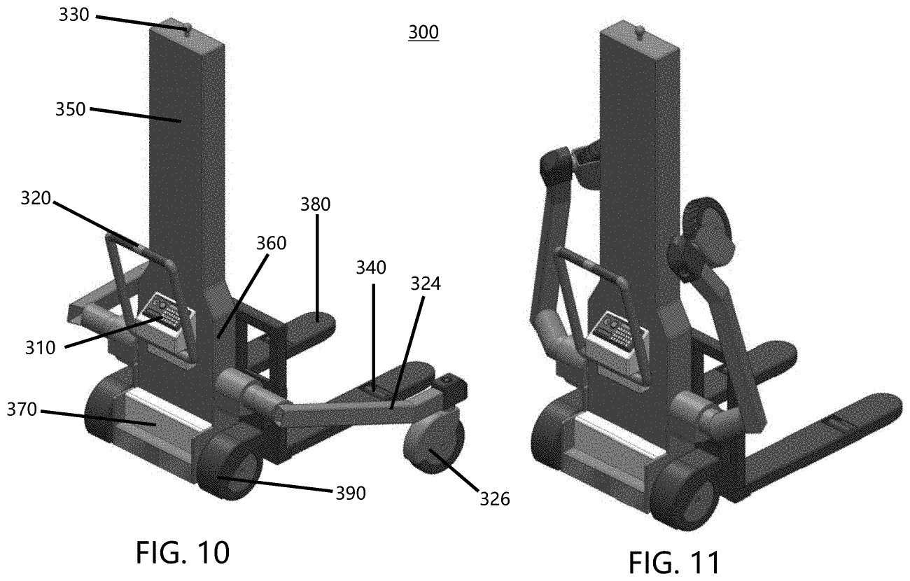

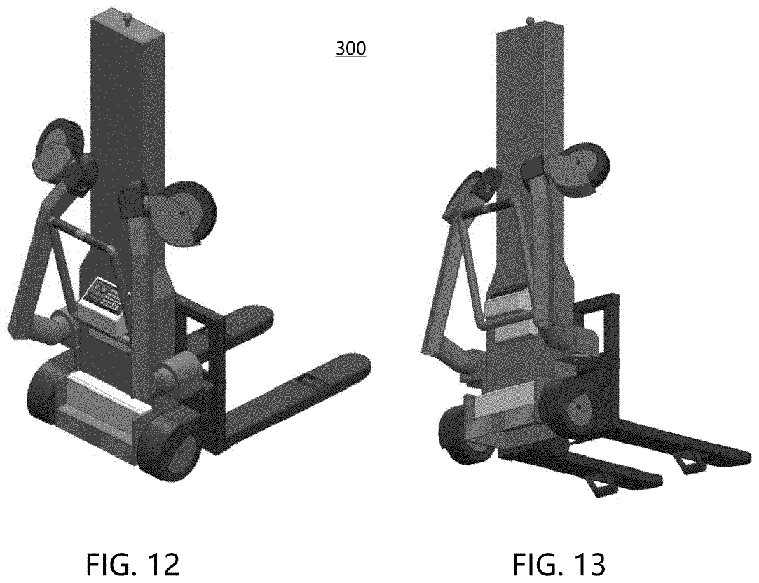

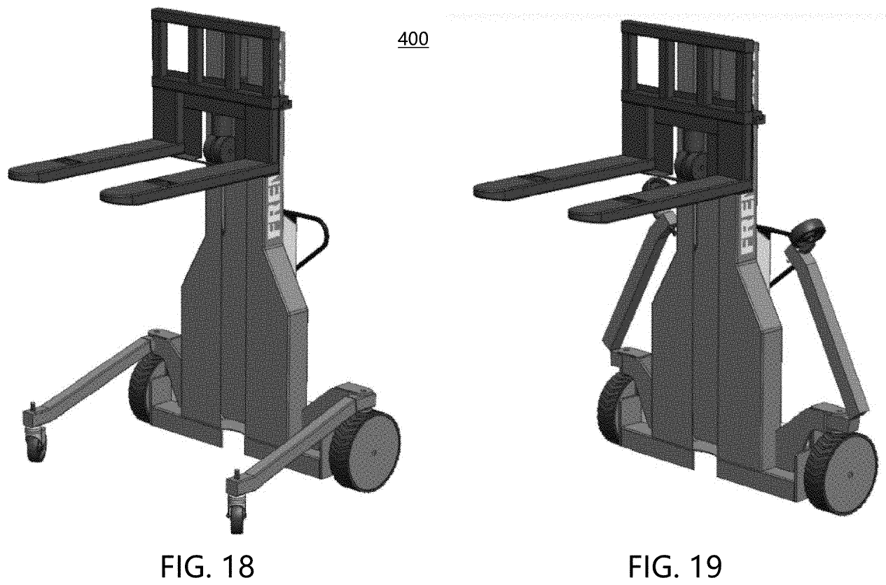

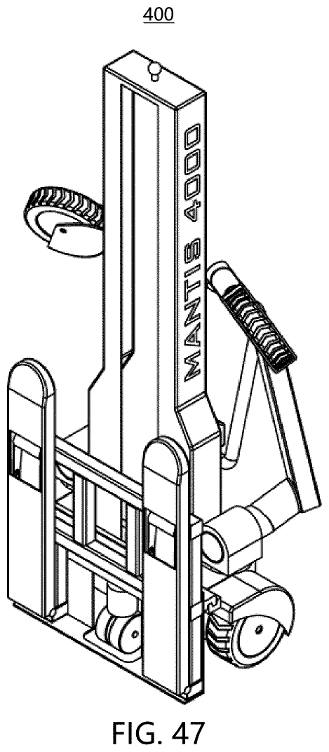

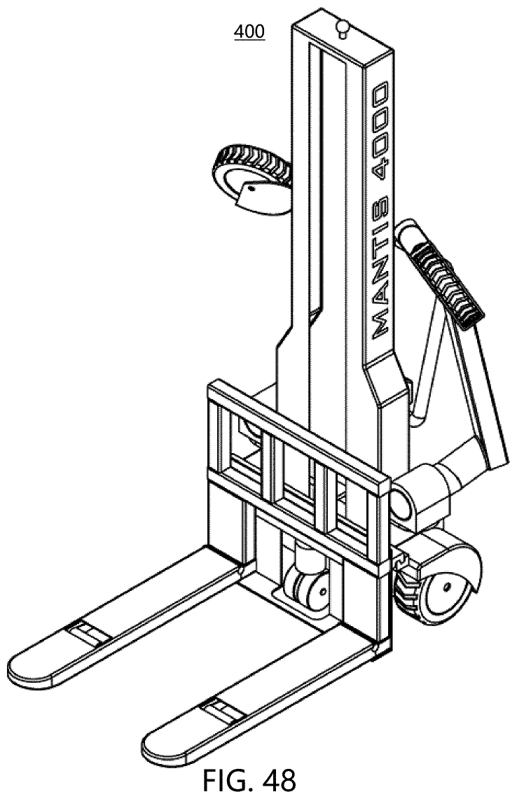

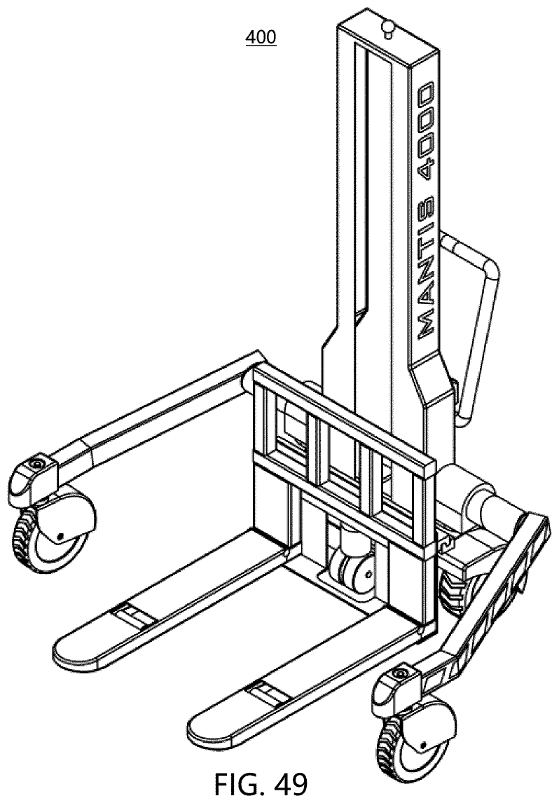

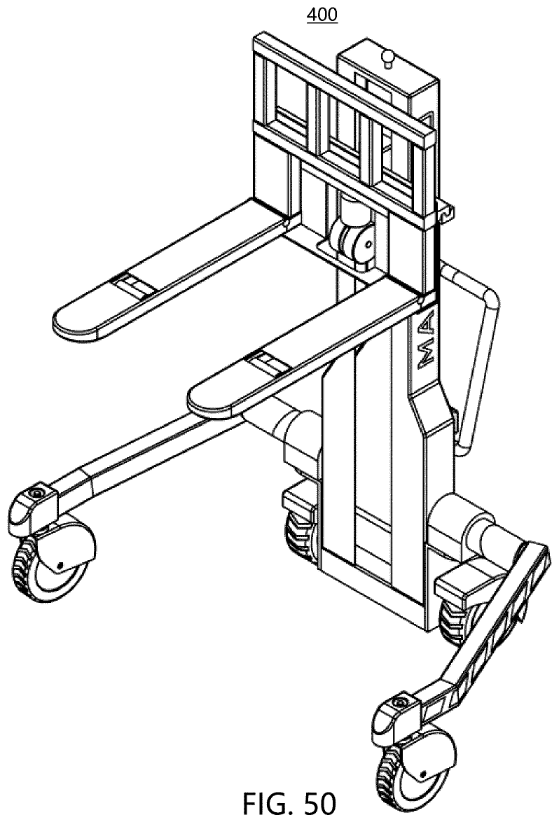

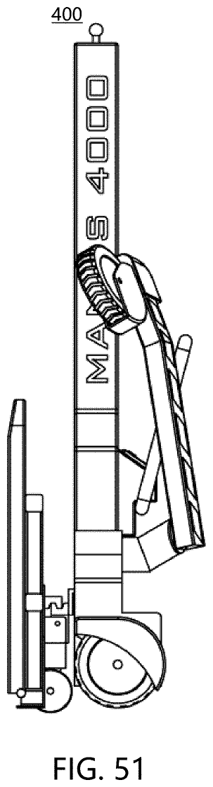

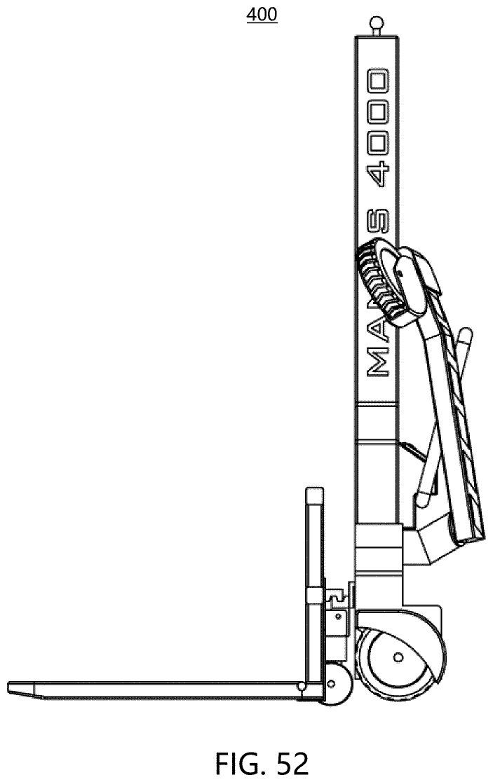

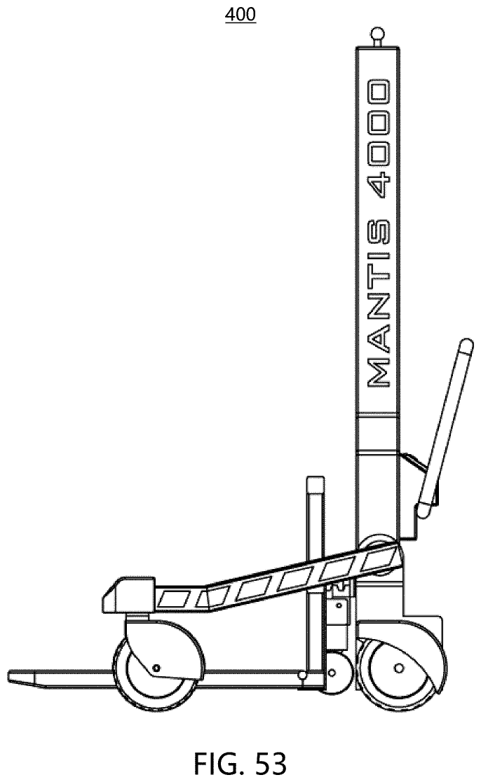

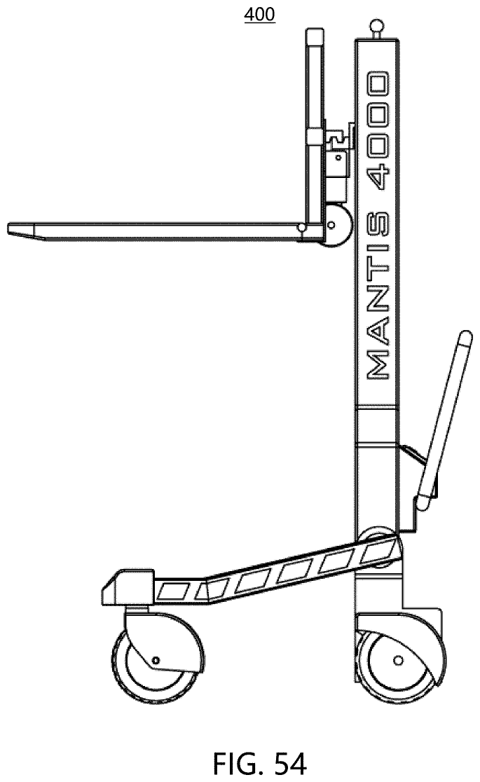

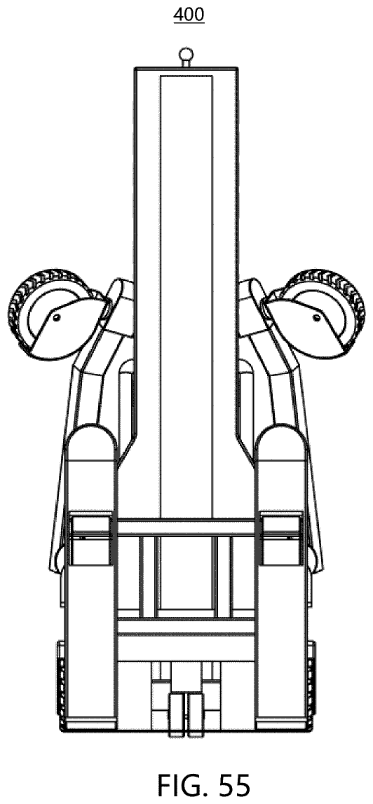

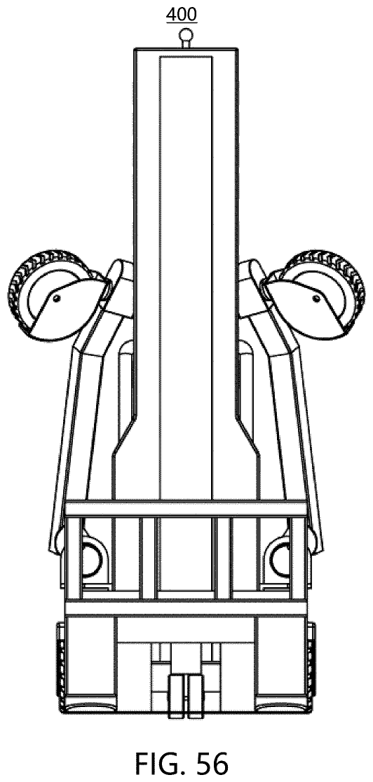

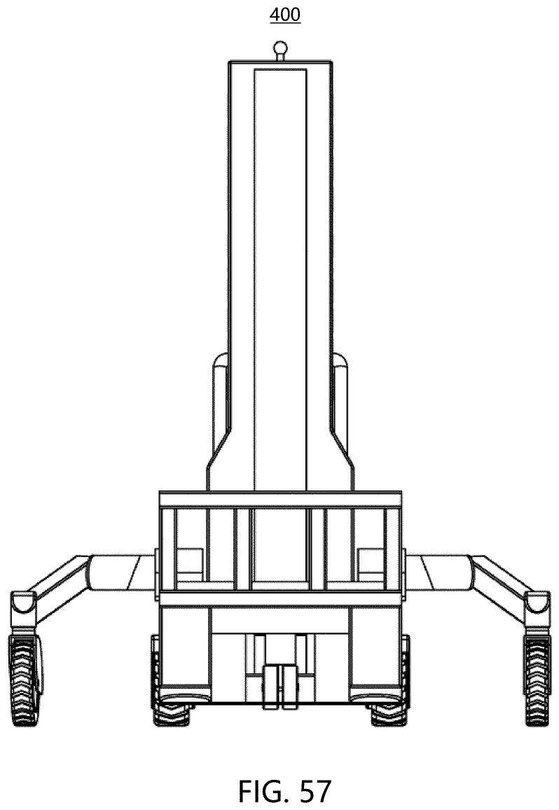

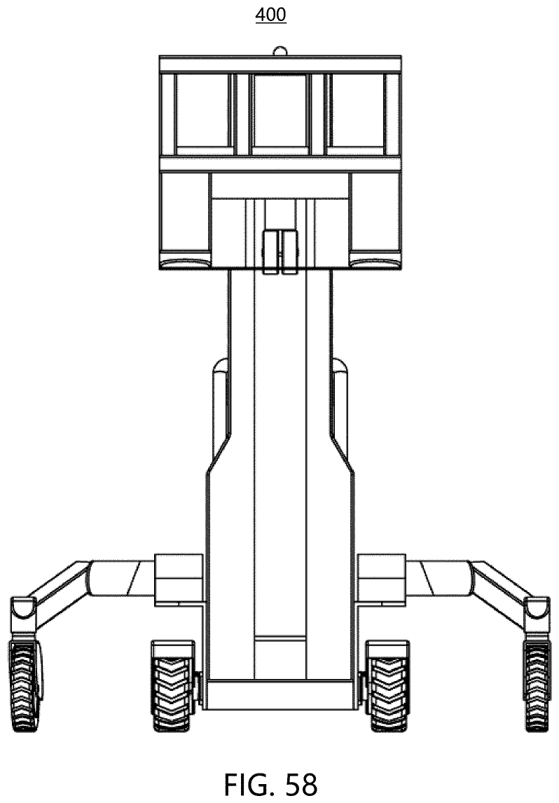

A third non-limiting embodiment of a lifting device 300 according to the present disclosure is illustrated in FIGS. 10-19 and 47-58. The lifting device 300 is formed of many components which are similar or identical to and operate in substantially the same manner as those described above with respect to lifting devices 100 and 200. Similar or identical components between devices 300 and 100 and/or 200 include an upright body, a carriage, a lifting mechanism, one or more sets of wheels or rollers, a support beam, one or more stanchion, forks, cutout portions for wheels, an enclosure or housing, a jack handle, electric motor, threaded screw, drive nut, motor cover, and a power source.

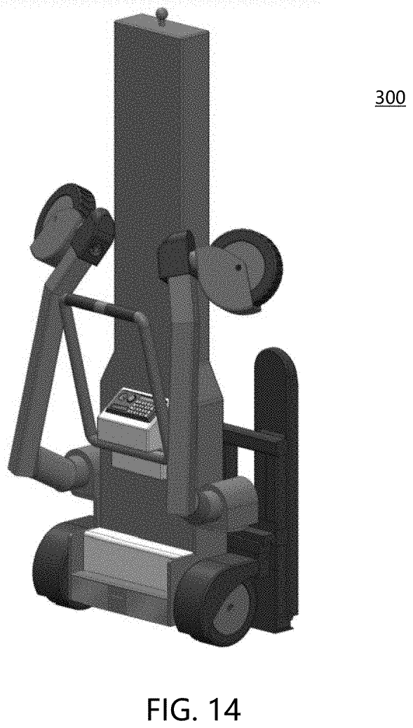

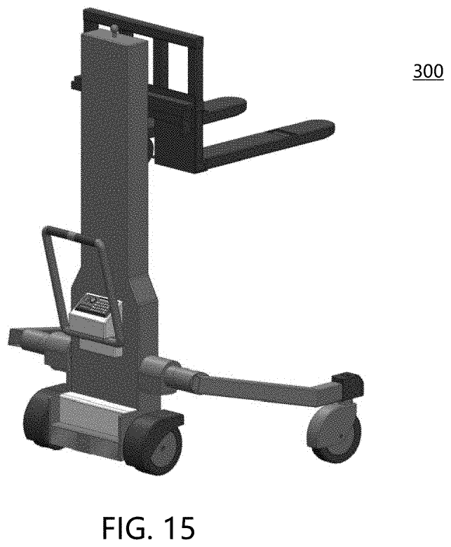

The lifting device 300 includes some components which are different from lifting devices 100 and 200. These components include, but are not limited to, the configuration and size of the rear wheels or rollers 390, the configuration of supporting arms 324 with wheels or rollers 326, the inclusion of wheel and/or roller 340 on the forks, the configuration of the fork 380, the location and configuration of the jack handle 320, the inclusion of a rear control panel/box 310, the configuration of the enclosure 350 and motor cover/housing 360, location and/or configuration of the power sources 370, the inclusion of the lift knob 330 on the top of the enclosure, and the folding profile of the lifting device (See FIGS. 11-14). Lifting device 300 can optionally be configured such that the operation of the lifting device is fully or partially controllable by the rear control panel/box 310, thus the jack handle 320 can be configured to only enable a user to reposition the lifting component, but is not used to operate the fork; however, this is not required. The rear control panel/box can optionally be used to operate the rear wheels to cause the lifting device to move in a desired direction (e.g., forwardly, rearwardly, turn left, turn right, etc.). As can be appreciated, the movement of the lifting device can also or alternatively be manually movable. The rear control panel/box can optionally be used to operate the supporting arms (e.g., cause the supporting arms to move to a stored position [See FIGS. 11-14, cause the support arms to move to a support/stabilization position [See FIGS. 10, 15], etc.). As can be appreciated, the support arm can also or alternatively be manually movable. The rear control panel/box can optionally be used to operate the fork to cause the fork to move to an up position (FIG. 15), cause the fork to move to a down position (FIGS. 10-13), and/or cause the fork to move to a stored position (See FIG. 14).

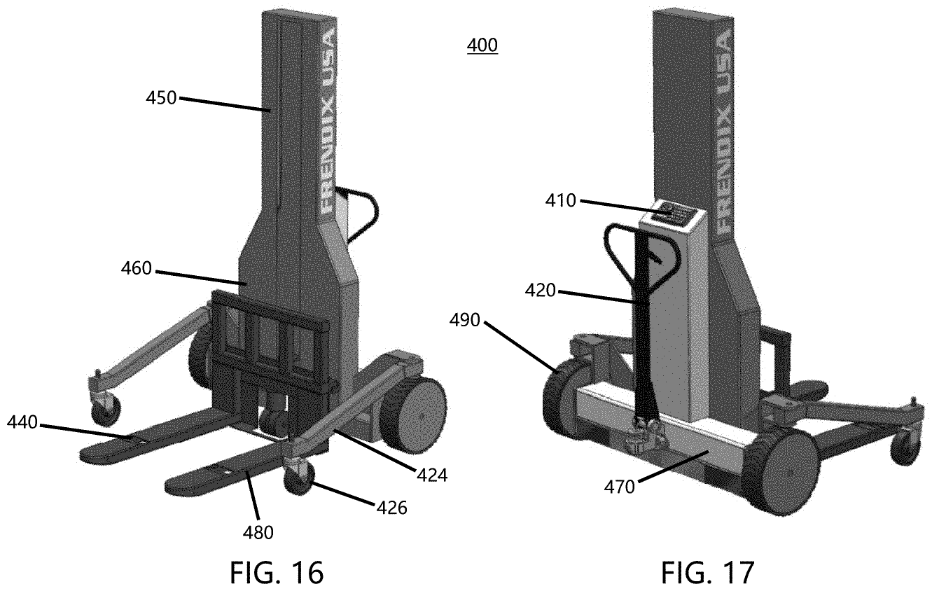

A fourth non-limiting embodiment of a lifting device 400 according to the present disclosure is illustrated in FIGS. 16-19. The lifting device 400 is formed of many components which are similar or identical to and operate in substantially the same manner as those described above with respect to lifting devices 100, 200, 300. Similar or identical components between devices 400 and 100, 200 and/or 300 include an upright body, a carriage, a lifting mechanism, one or more sets of wheels or rollers, a support beam, one or more stanchions, forks, cutout portions for wheels, an enclosure or housing, a jack handle, electric motor, threaded screw, drive nut, motor cover, and a power source.

The lifting device 400 includes some components which are different from lifting devices 100, 200 and 300. These components include, but are not limited to, the configuration and size of the rear wheels or rollers 490, the configuration of supporting arms 424 with wheels 426, the inclusion of wheels and/or rollers 440 on the forks, the configuration of the fork 480, the location and configuration of the jack handle 420, the inclusion of a rear control panel/box 410, the configuration of the enclosure 450 and motor cover/housing 460, location and/or configuration of the power sources 470, and the folding profile of the lifting device. Lifting device 400, similar to lifting device 300, can optionally be configured such that the operation of the lifting device is fully or partially controllable by the rear control panel/box 410, thus the jack handle 420 can be configured to only enable a user to reposition the lifting component, but is not used to operate the fork; however, this is not required. The rear control panel/box can optionally be used to operate the rear wheels to cause the lifting device to move in a desired direction (e.g., forwardly, rearwardly, turn left, turn right, etc.). As can be appreciated, the movement of the lifting device can also or alternatively be manually movable. The rear control panel/box can optionally be used to operate the supporting arms (e.g., cause the supporting arms to move to a stored position [See FIG. 19], cause the support arms to move to a support/stabilization position [See FIGS. 16-18], etc.). As can be appreciated, the support arm can also or alternatively be manually movable. The rear control panel/box can optionally be used to operate the fork to cause the fork to move to an up position, cause the fork to move to a down position, and/or cause the fork to move to a stored position.

The lifting devices 100, 200, 300, 400 of the present disclosure may also be provided with a variety of other known devices facilitating the pushing, pulling, and lifting of an associated load. For example, the construction of carriages for the presently disclosed lifting devices 100, 200, 300, 400 and the positions of the supporting arms can be selected to allow the handling of standard closed-bottom pallets having bottom stringers. As can be appreciated, the supporting arms can also or alternatively be configured to be used with lifting items other than pallets. The wheels of lifting devices 100, 200, 300, 400 may be provided with a known transmission using either the same power source as lifting mechanisms or a separate one. The lifting devices 100, 200, 300, 400 can optionally be provided with driving wheels in the manner described above and enable the moving of heavier loads as well as moving on gradients (including both inclines and declines). One or more counterweights can optionally be provided to balance a tipping force that may appear in planar moving of an unloaded lifting device 100, 200, 300, 400.

The lifting devices 100, 200, 300, 400 according to the present disclosure may replace a tail lift mounted on a vehicle and can be used for the handling of a variety of loads (e.g., those intended to be transported by means of so-called hand pallet trucks both outside the vehicle and in the platform space). The lifting devices 100, 200, 300, 400 can also be used in other forms of load transport and handling, such as in cases involving the changing of a travelling plane that cannot be carried out travelling on wheels.

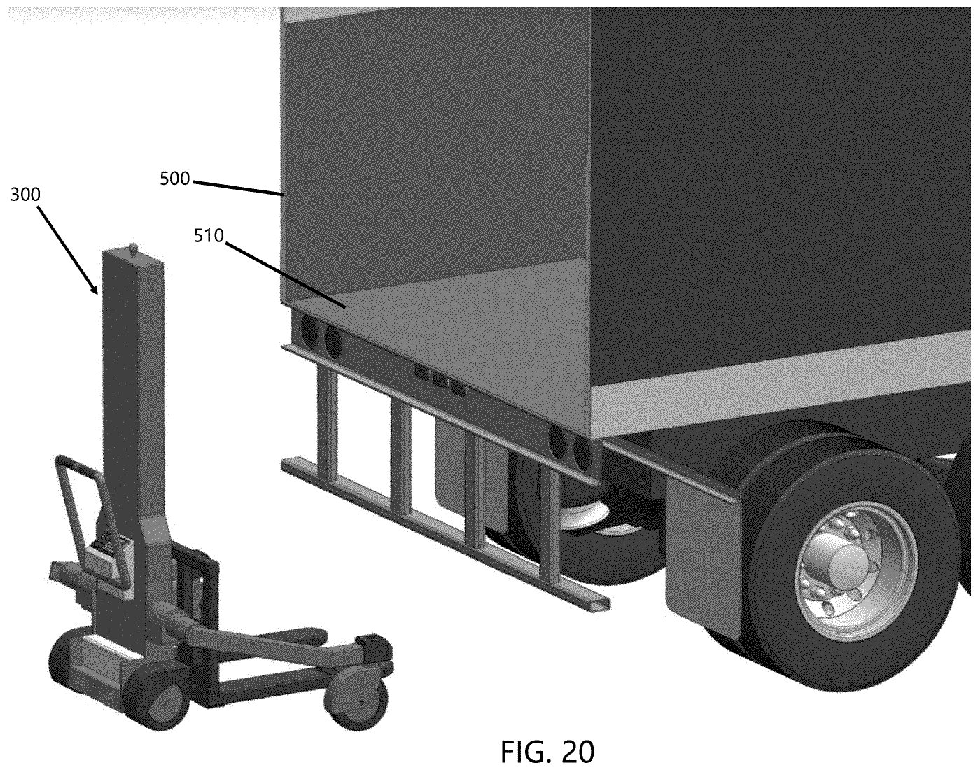

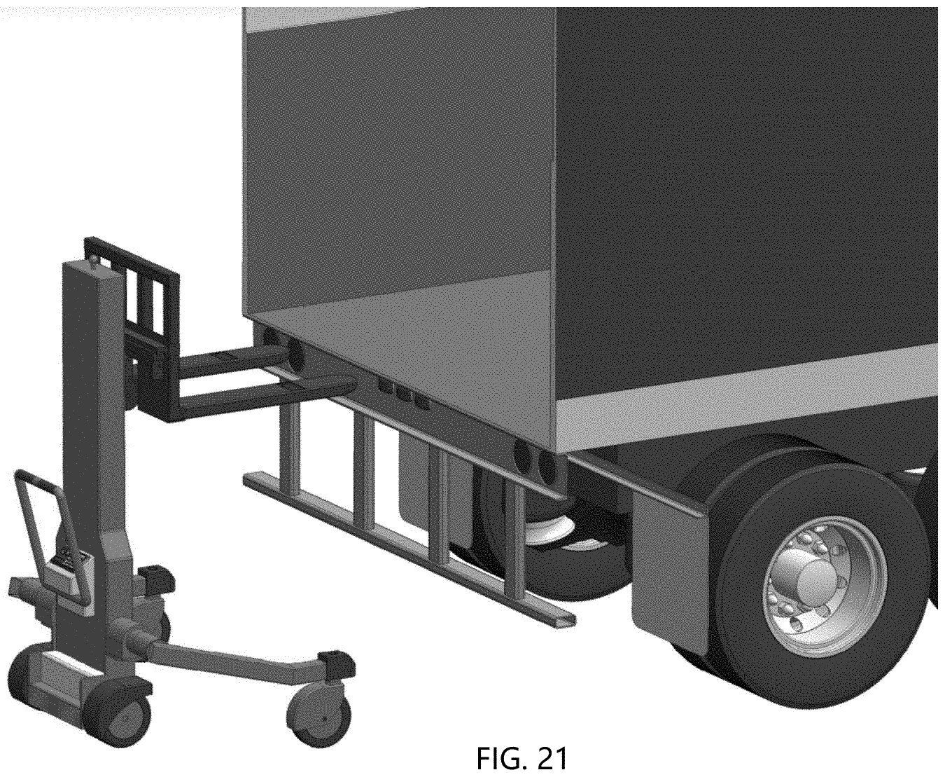

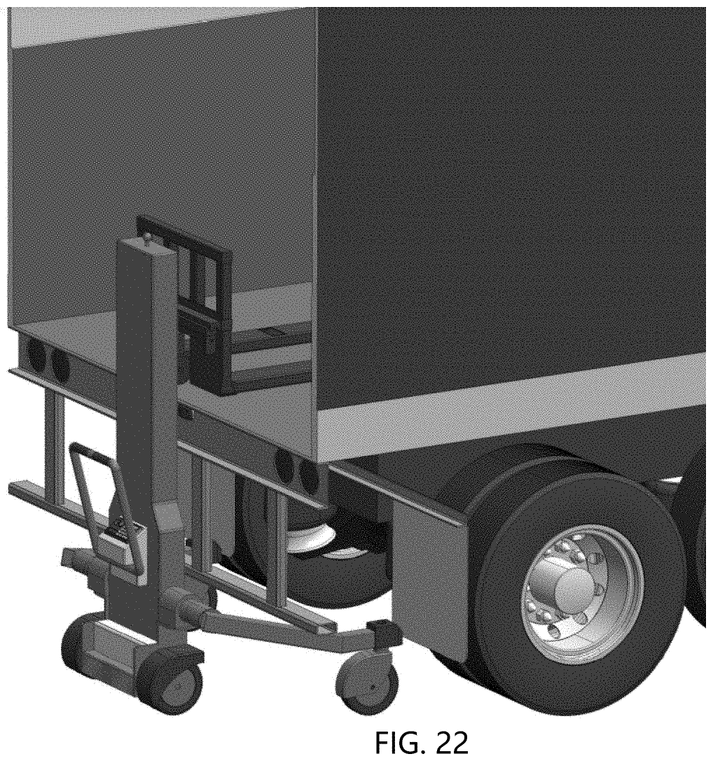

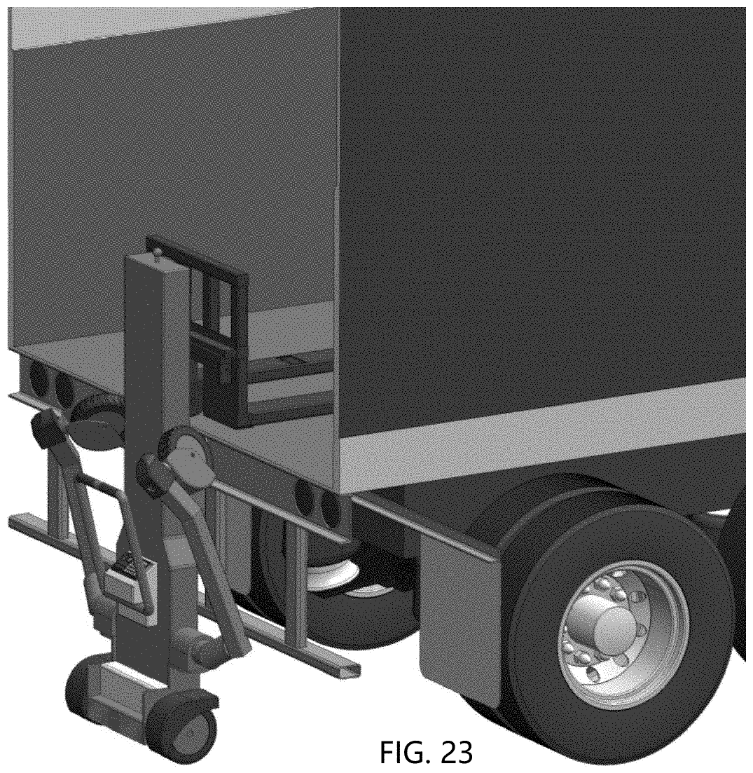

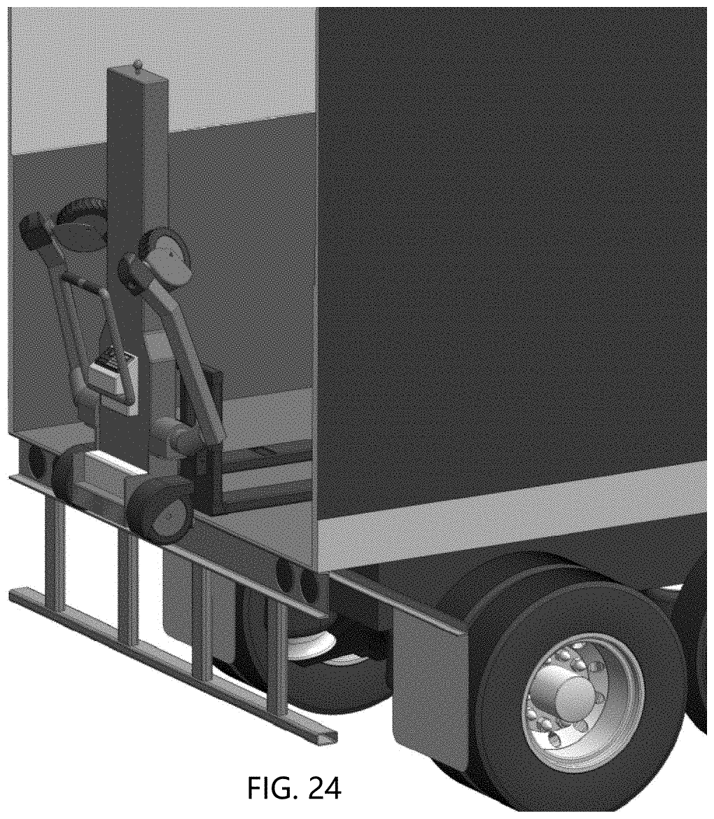

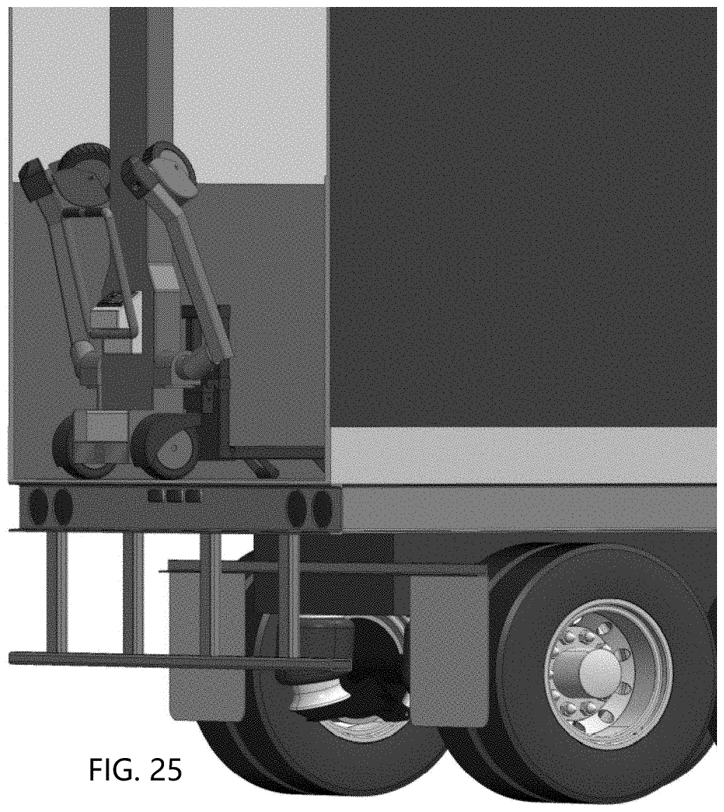

Referring now to FIGS. 20-25, the operation of lifting devices 100, 200, 300, 400 is illustrated. Although the specific configuration of lifting device 300 is illustrated in FIGS. 20-25, the operation of lifting devices 100, 200, 400 is generally the same or very similar. FIG. 20 illustrates the lifting device in a position where it will be used to engage a pallet, etc., on a ground surface to be lifted into the trailer 500 of a truck. FIG. 21 illustrates the lifting device in a raised position wherein if a pallet was positioned on the fork, the pallet is raised above the interior floor 510 of the trailer. FIG. 23 illustrates the lifting device in a raised position and moved toward the trailer such that the fork is located above the interior floor of the trailer. FIG. 24 illustrates the lifting device in a raised position and moved toward the trailer. The fork is located above the interior floor of the trailer, but has been lowered such that the fork lower than illustrated in FIG. 23 such that the fork is in contact with or slightly above the interior floor of the trailer such that if a pallet is on the fork, the pallet is on or nearly in contact with the interior floor of the trailer. FIG. 24 illustrates the raising of the lifting device onto the interior floor surface of the trailer. FIG. 25 illustrates the lifting device that has been moved into the interior of the trailer after being raised as illustrated in FIG. 24. As illustrated in FIGS. 20-25, the lifting device can be used to load and unload a trailer filled with pallets, boxes, containers, and/or other items. As also illustrated in FIGS. 20-25, the lifting device can be raised and stored in the interior of a trailer or other transport vehicle (e.g., flatbed truck, etc.). As also illustrated in FIGS. 20-25, the lifting device can be lowered from the interior of a trailer or other transport vehicle (e.g., flatbed truck, etc.). As also can be appreciated, the lifting device can be used to move items over different leveled surfaces (e.g., docks that have two or more levels, surfaces that have one or more steps between surfaces, etc.).

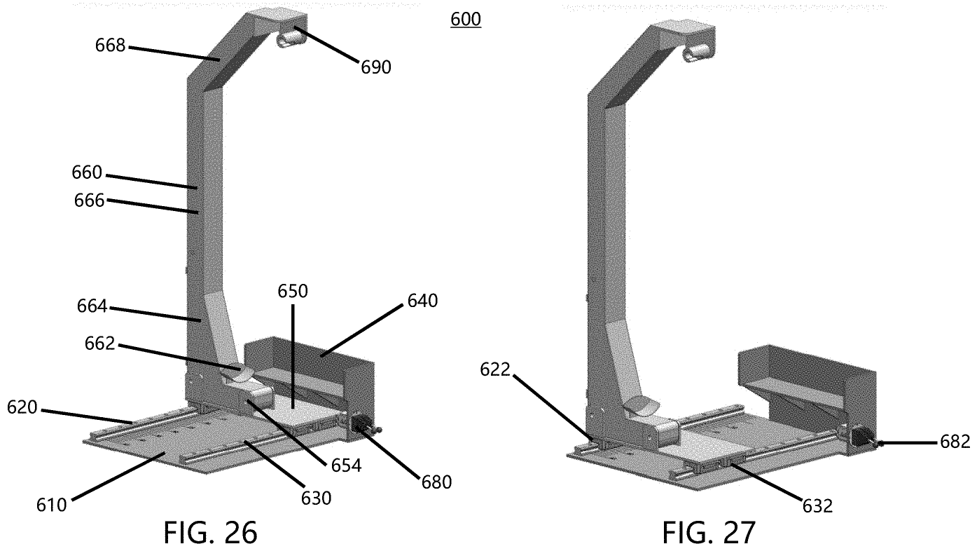

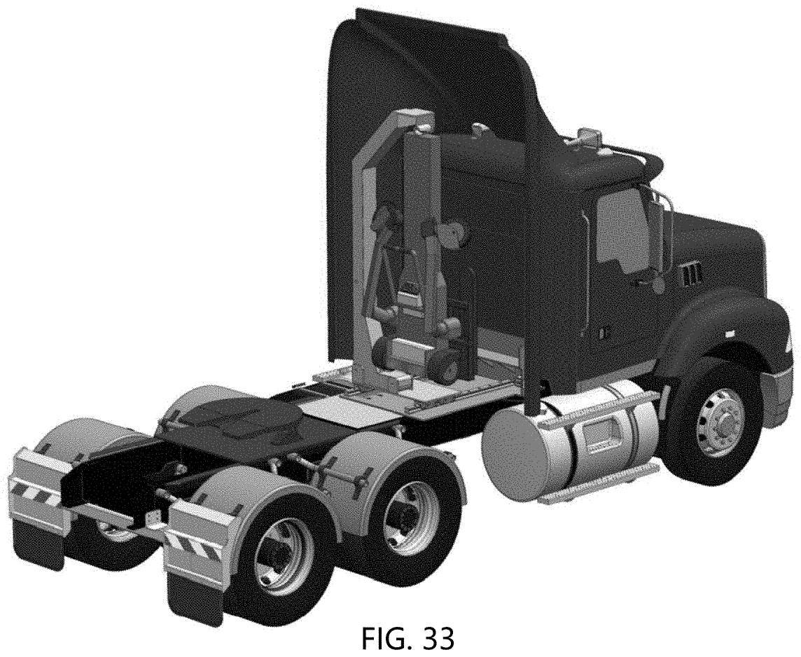

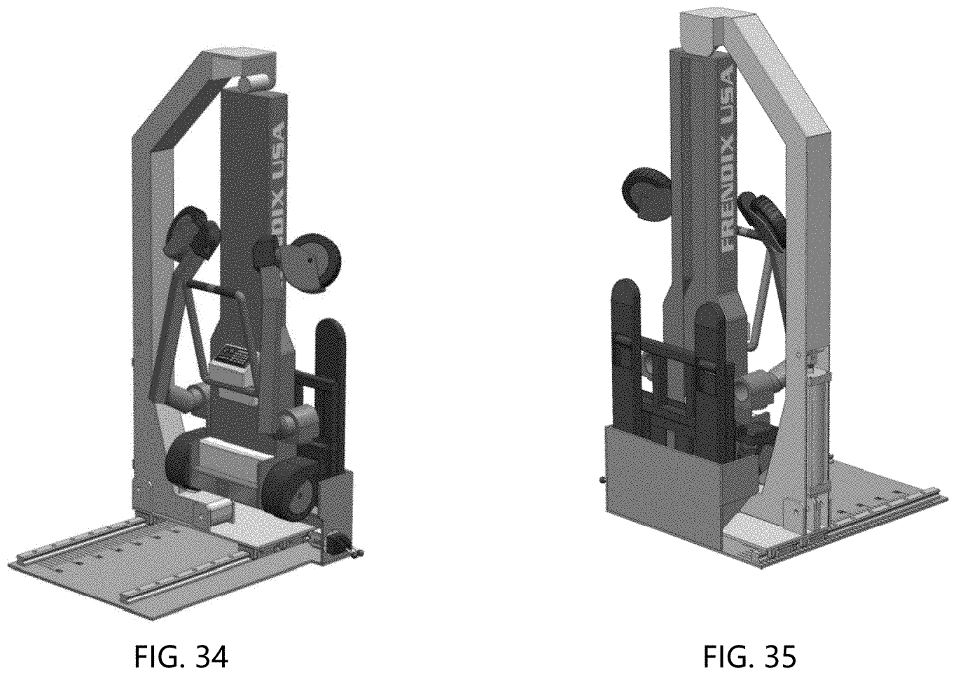

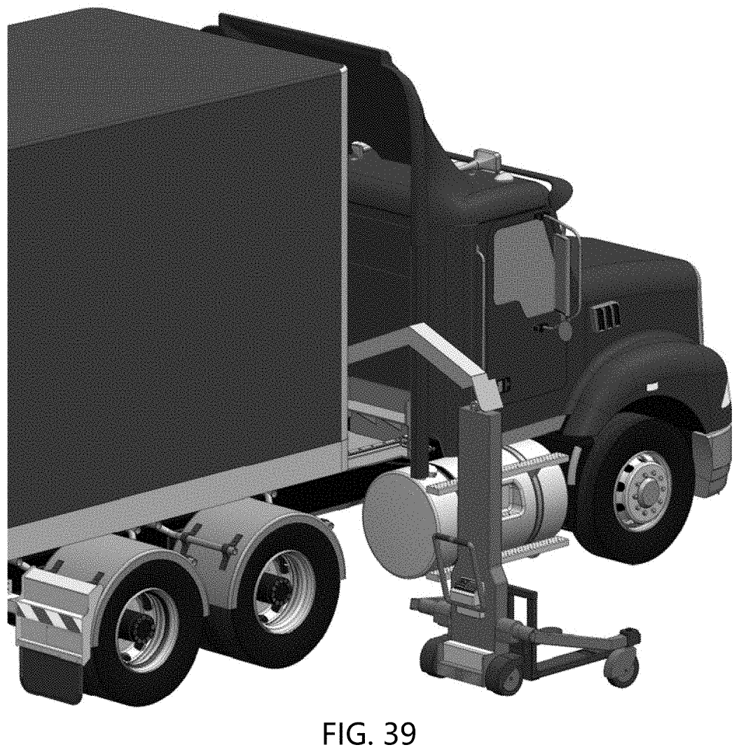

Referring now to FIGS. 26-40, there is illustrated a loading arrangement 600 that can optionally be used with the lifting device. The loading arrangement is designed to be mounted to the rear portion of the track cab such that the lifting device can be loaded, stored, and unloaded from the rear portion of the truck cab. When the truck includes a trailer connected to the truck cab, the loading arrangement can be used to load, store and/or unload the lifting device from the rear portion of the truck cab without having to disconnect the trailer from the truck cab. As can be appreciated, the loading arrangement can be used on other types of vehicles (e.g., flat bed truck, etc.), loading docks, boats, trains, etc.

The loading arrangement 600 includes a base 610, slide rails 620, 630, side landing 640, slide platform 650, lift arm 660, and controller 680. The materials used to form the structural components of the loading arrangement are generally formed of a metal material; however, other durable materials can be used.

As illustrated in FIGS. 26-27, the base 610 is generally a planar material. The two sliding rails 620, 630 are mounted to the top surface of the base (e.g., bolts, screws, welding, adhesive, etc.). The slide platform is slidably connected to the slide rails. As can be appreciated, other types of movement/sliding arrangements can be used to enable the slide platform to move relative to the base. As illustrated in FIG. 27, the slide brackets 622, 632 are connected to the bottom surface of the slide platform. The slide brackets are configured to slideably engage and secure the slide platform to the two slide rails.

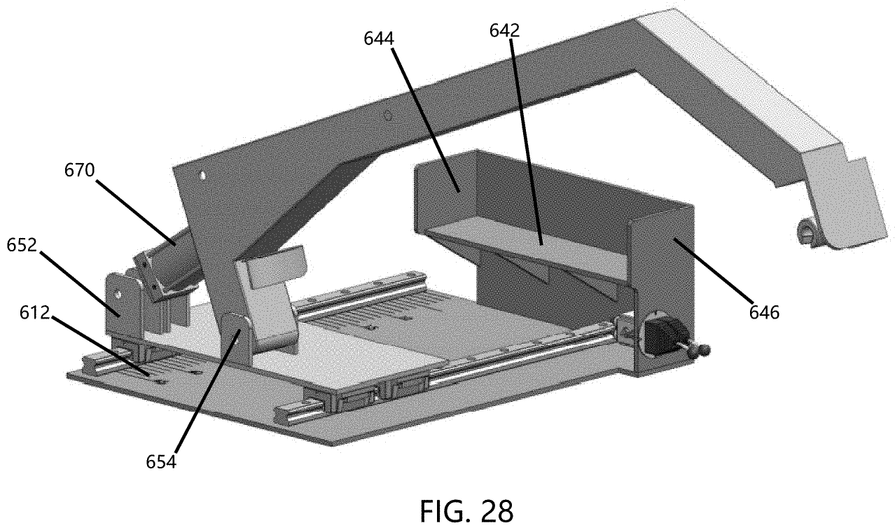

The top surface of the slide platform can optionally include a reference grid 612 to enable a user to measure or otherwise determine the position of the slide platform relative to the base. Such optional grid can be used to enable a user to facilitate in the loading and unloading of the lifting device from a vehicle, platform, etc. The grid can include numbers, letters, etc. As illustrated in FIG. 28, the grid includes numbers representing a measurement unit (inches, feet, etc.) that identifies the distance the slide platform is from a side edge of the base.

A lift arm 660 is pivotally connected to the slide platform. Pivot brackets 654 are secured to the slide platform and are used to pivotally connect the lift arm to the slide platform. As can be appreciated, other arrangements can be used to pivotally connect the lift arm to the slide platform.

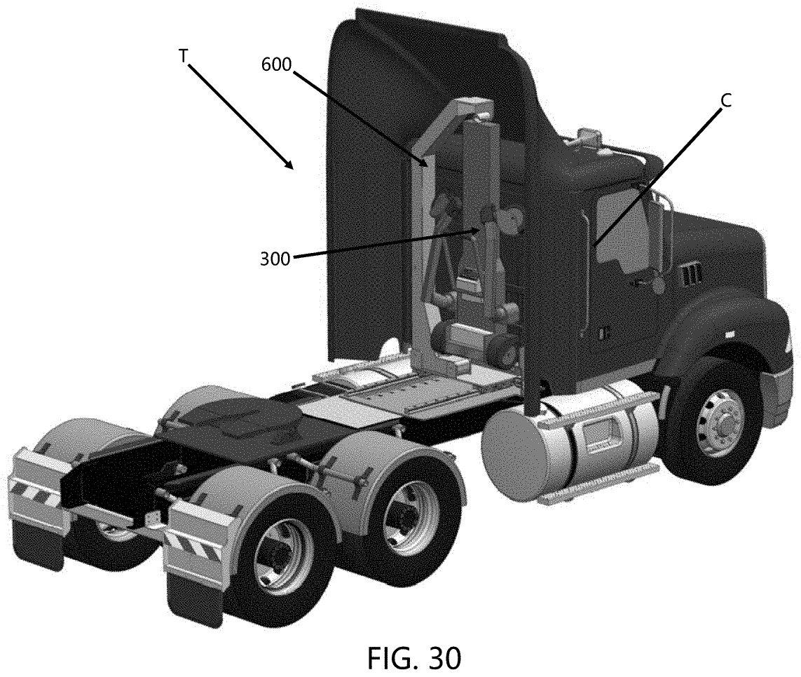

An optional wheel landing 662 is located at the base portion of lift arm. As can be appreciated, an optional wheel landing can also or alternative be located on the slide platform. The optional wheel landing is used to facilitate in securing the lifting device on the loading arrangement when the lifting device is in the stored position on the loading arrangement (See FIGS. 30, 31, 34). The optional wheel landing is configured to function as a wheel landing for at least one of the rear wheels of the lifting device. The optional wheel landing can optionally have an arcuate shape.

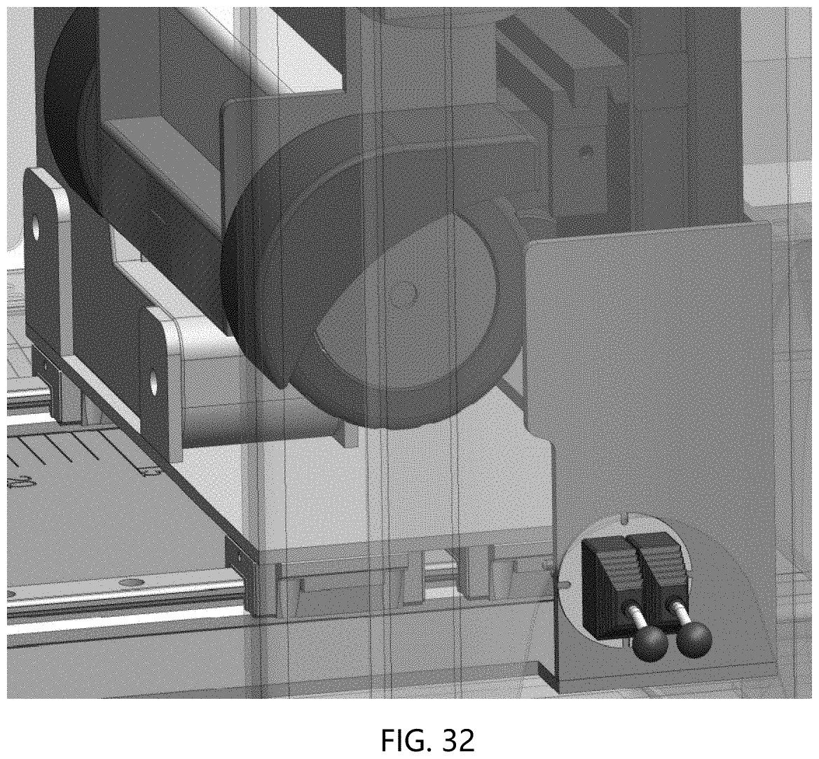

The slide platform can also optionally include a side landing 640 that can be used to facilitate in securing the lifting device on the loading arrangement when the lifting device is in the stored position on the loading arrangement (See FIG. 32). The side landing can include a landing base 642 and two side walls 644, 646. The side landing can be configured to partially or fully receive a portion of the motor housing and/or the enclosure of the lifting device when the lifting device is in the stored position on the load arrangement.

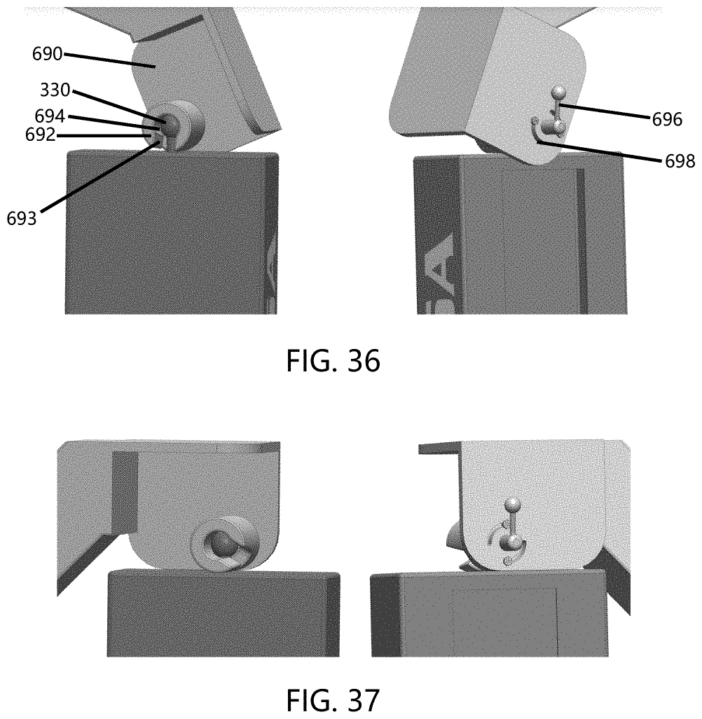

The lift arm can optionally include a wide base region 664, a middle region 666, and an angle arm region 668. A device connector 690 is connect to the lift arm, such as the angle arm region of the lift arm. As illustrated in FIGS. 36-37, the device connector 690 is configured to be releasably connected to the lift knob 330 on the top of the enclosure of the lifting device. In one non-limiting arrangement, the device connector includes a rotatable connection bracket 692 that includes a connection slot 693 and a connection cavity 694. As illustrated in FIG. 36, when the connection bracket is on the open position, the lift knob can be inserted into or removed from the connection cavity. When the connection bracket if rotated to the closed position (as illustrated in FIG. 37), the lift knob, when located in the connection cavity, is secured in the connection cavity. The connection bracket can be rotated between the open and closed positions by locking lever 696. The range of movement of the locking lever can optionally be limited by one or more limit slots 698. As can be appreciated, other arrangements can be used to releasably connect the lifting arrangement to the lift arm.

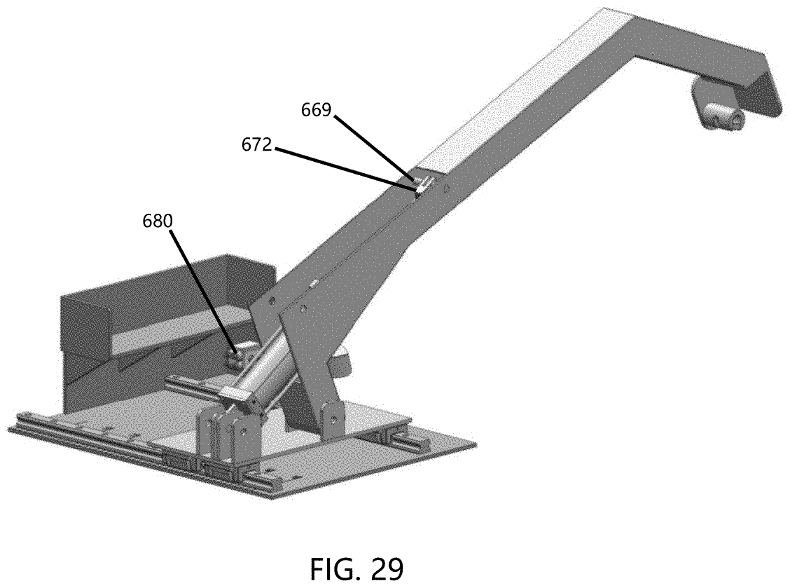

The movement of the lift arm can be controlled by controller 680. The controller can optionally include one or more control levers 682 to control the movement of the lift arm and/or the slide platform. The controller is configured to move the lift arm between the up position (See FIG. 26-27), and the down position (See FIGS. 28-29). The controller can also or alternatively be used to control the movement of the slide platform relative to the base between the stowed position (See FIGS. 26, 34, 35) and the non-stow position (See FIG. 27). A motor and gear or chain arrangement can optionally be used to move the slide platform relative to the base; however, other arrangements can be used to move the slide platform relative to the base (e.g., magnets, rods, cord, chain, hydraulics, linear motion machine, etc.).

As illustrated in FIG. 28-29, a hydraulic piston or linear actuator 670 is used to move the lift arm between the up position and the down position. The hydraulic piston or linear actuator 670 is connected at one end to piston brackets 652 that are connected to the slide platform 650. The hydraulic piston or linear actuator 670 is generally pivotally connected to the piston brackets; however, other connection arrangements can be used to connect the hydraulic piston or linear actuator 670 to the slide platform. The opposite end of the hydraulic piston or linear actuator includes a rod 672 that is connected to the lift arm. As illustrated in FIG. 29. The end of the rod 672 is pivotally connected to the lift arm by arm bracket 669. In one non-limiting arrangement, when the rod is retracted, the lift arm moves to the up position, and when the rod is extended, the lift arm moves to the down position.

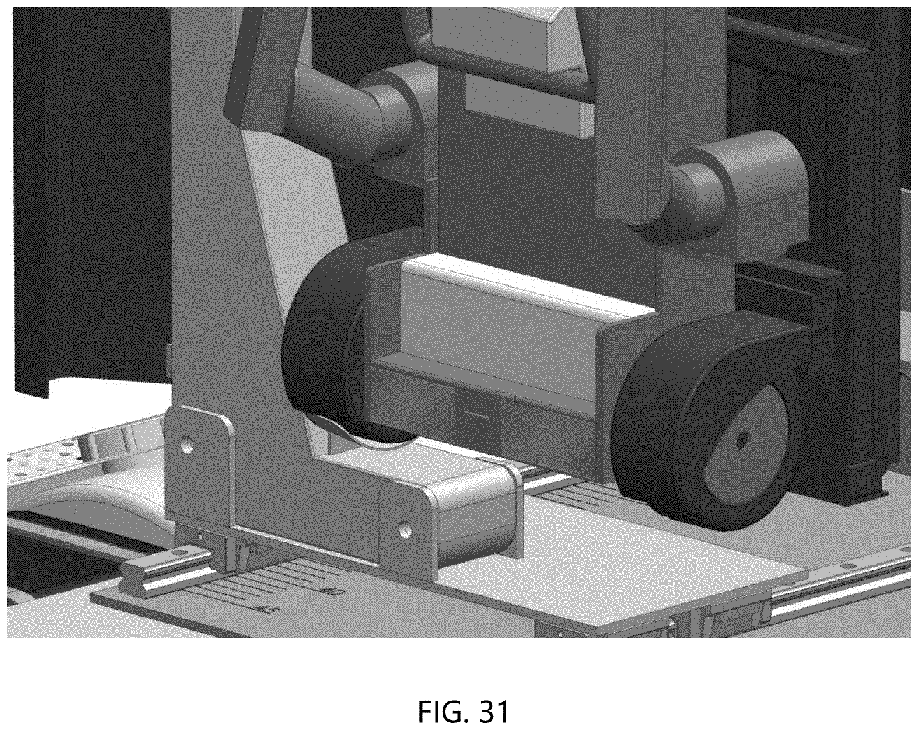

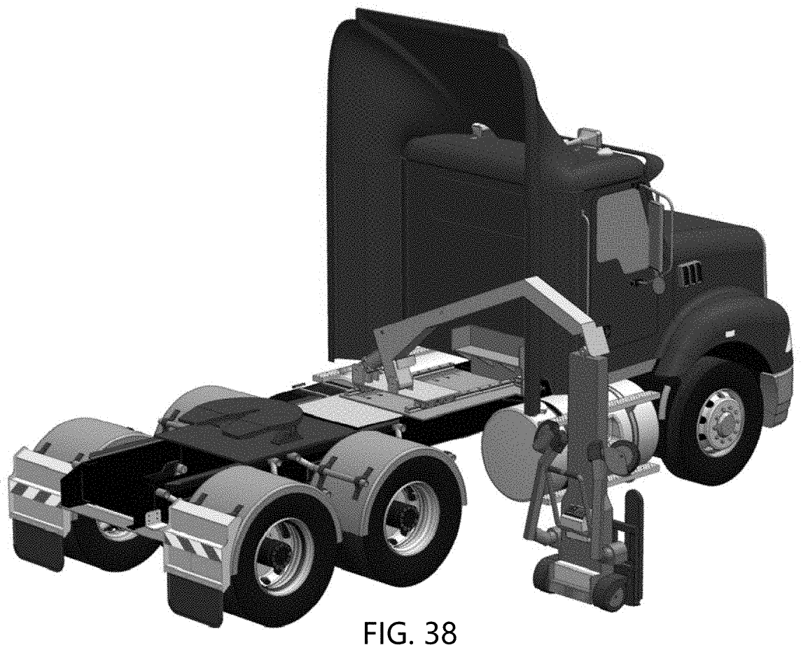

As illustrated in FIG. 30, the loading arrangement can be mounted to a region of the truck T that is located rearwardly of the cab C. FIG. 30 illustrates the lifting device loaded on the loading arrangement in the fully stowed position. FIG. 31 illustrates the loading device moved to the non-stowed position wherein the slide platform as been moved to a position father from the cab. FIG. 38 illustrates the lift arm in the down position to cause the lifting device to be moved to a ground surface. Once the lifting device is on the ground surface, the device connector can be moved to the open position to enable the lifting device to be released from the lift arm. The operations described above can be reversed to once again fully stow the lifting device on the truck.

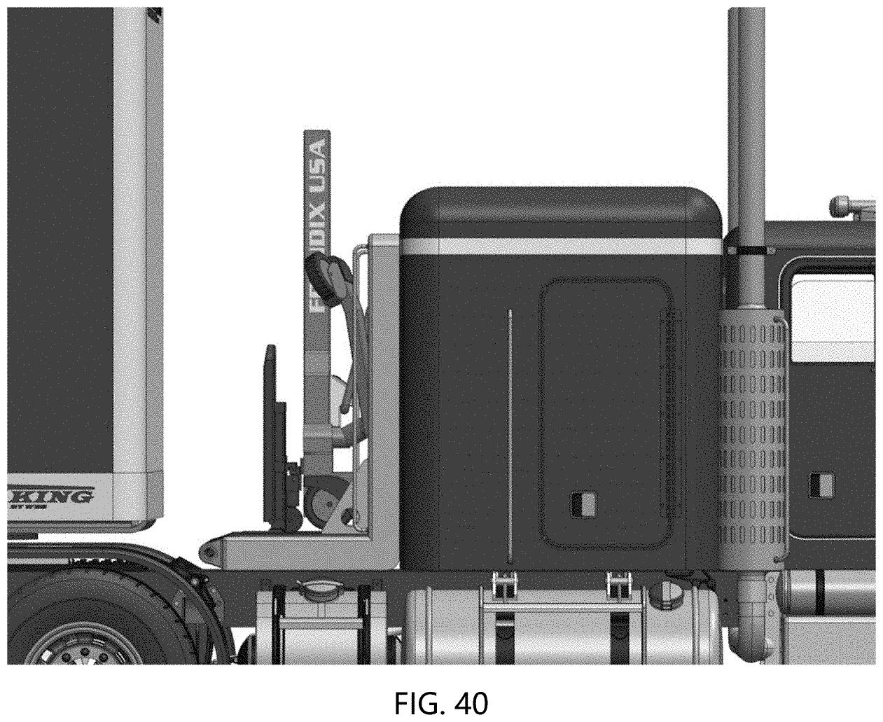

FIG. 40 illustrates an alternative arrangement for stowing the lifting device at the rear of the cab of a truck. In such an arrangement, a separate loading arrangement (e.g., crane, etc.) that is not located on the truck (not shown) can be used to lift and remove the lifting arrangement from the truck and to load the lifting device on the truck.

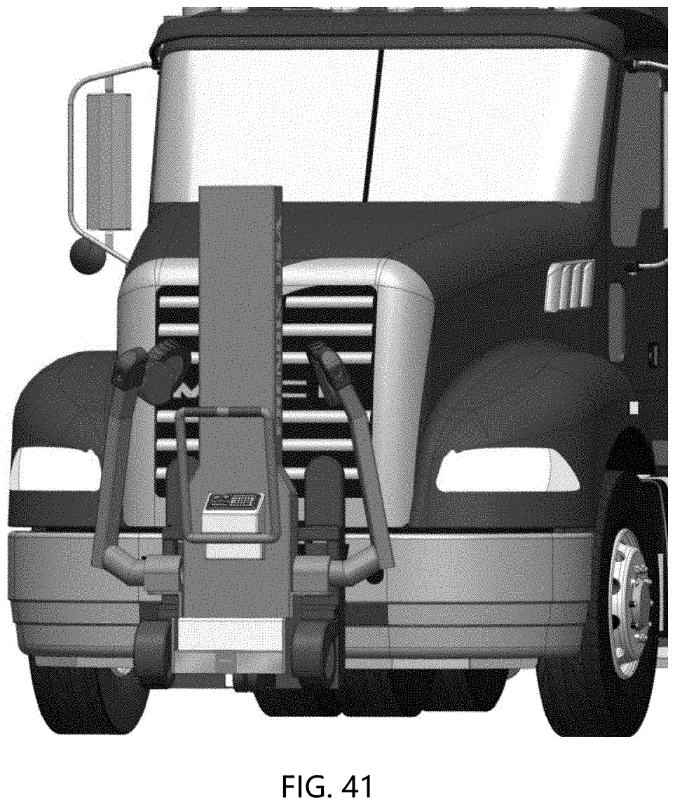

FIG. 41 illustrates the lifting device connected to the front end of the truck. Various types of brackets, clamps, rope, chain, cord, etc., can be used to releasably secure the lifting device to the front end of the truck.

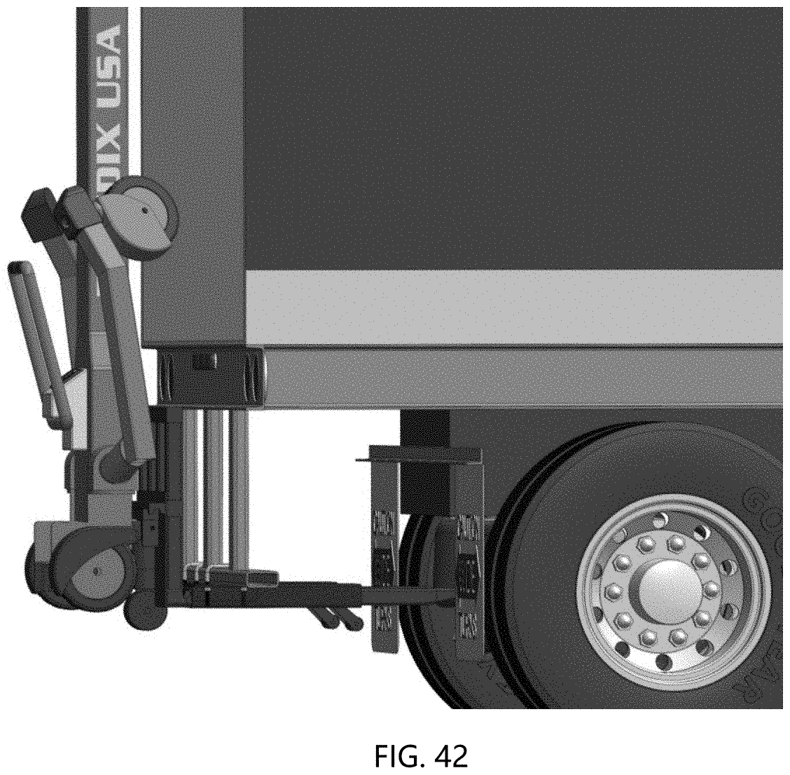

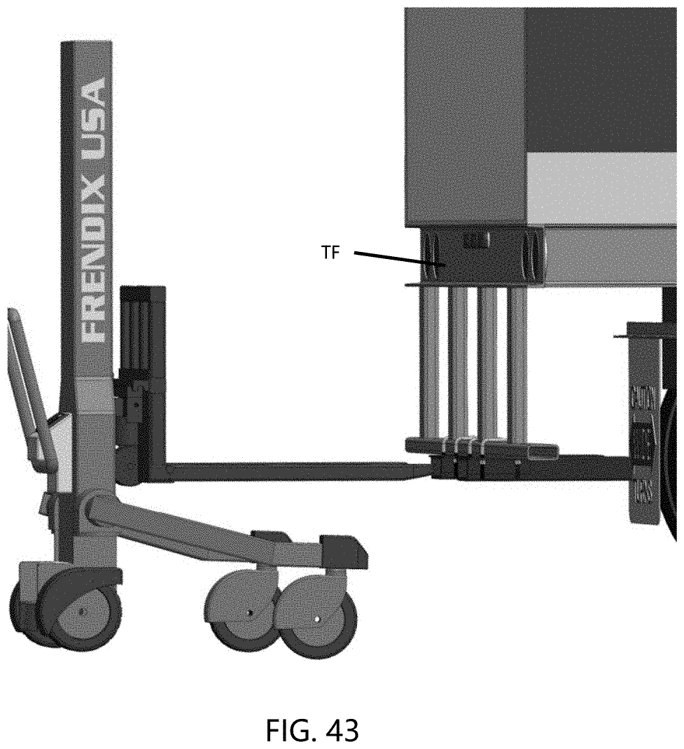

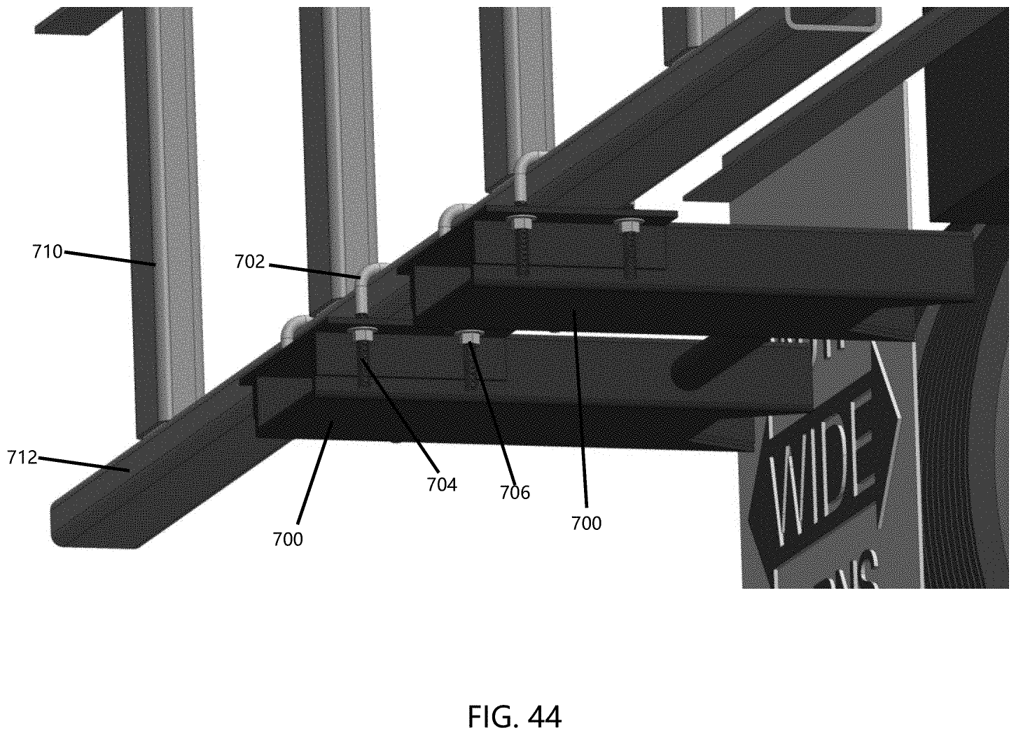

FIGS. 42-44 illustrate an arrangement for releasably securing the lifting device to the rear of a trailer of a truck. As illustrated in FIG. 44, connection tubes 700 are used to releasably secure the fork of the lifting device to the trailer. As illustrated in FIG. 43, rod supports 710 extend downward from trailer frame TF. One end of the rod supports can be connected to the trailer frame by any arrangement (e.g., bolts, weld, pins, etc.). The opposite end of the rod supports is connected to a support bar 712. The support bar is positioned above a ground surface. Two connection tubes 700 are connected to the support bar. The connection arrangement is illustrated as bracket bolts 702 and as nuts 706 that are threaded to thread 704 of the bracket bolts. As can be appreciated, other arrangements can be used to secure the connection tubes to the support bar (e.g., weld, bolts, screws, cord, brackets, clamps, etc.).

As illustrated in FIGS. 42 and 43, the fork of the lifting device is raised until the height of the fork is even with the openings in the connection tubes. Thereafter, the lifting device is moved forward to cause a portion of the forks to be inserted into the connection tubes. Thereafter, the fork is lowered to cause the lifting device to be raised from a ground surface. The lifting device can be secured to the end of the trailer by various arrangement (e.g., straps, chain, clamps, etc.) to releasably secure the lifting device to the rear of the trailer. The above step can be reversed to detach the lifting device from the rear of the trailer.

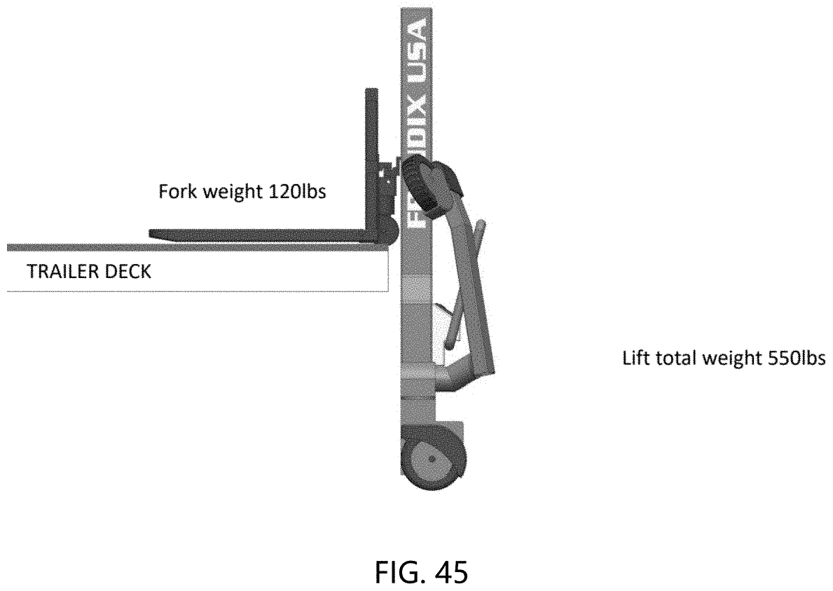

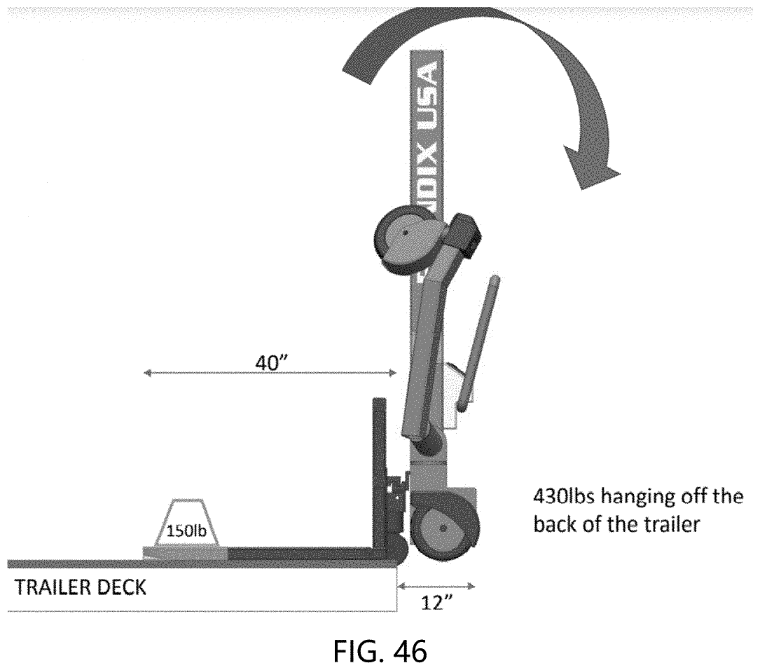

FIGS. 45-46 illustrate non-limiting specifications of one embodiment of the lifting device.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the preferred embodiments. These and other modifications of the preferred embodiments as well as other embodiments of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

1. A lifting device as discussed above and which is illustrated in FIGS. 1-58.

2. A method of operating a lifting device as discussed above and which is illustrated in FIGS. 1-58.

3. A method of releasably securing a lifting device to a vehicle as discussed above and which is illustrated in FIGS. 1-58.

4. A method for loading and unloading a lifting device on a vehicle or onto the trailer of the vehicle as discussed above and which is illustrated in FIGS. 1-58.

5. A loading arrangement for a lifting device as discussed above and which is illustrated in FIGS. 26-39.

6. A method for using a loading arrangement for a lifting device as discussed above and which is illustrated in FIGS. 26-39.

7. An improved lifting devices configured to a) lift itself into and out of a carbo bay of a trailer, b) onto and off a deck of a truck, c) onto and/or off a surface that is located at one plane of elevation to another surface that has a different plane of elevation, d) move objects from one plane of elevation to another surface that has a different plane of elevation, and/or e) lift objects and then move the lifted object to another location and then lower the object at the other location.

8. The improved lifting device as defined in claim 7 includes a main body, a lift housing that is connected to said main body, a fork structure that is movable a long at least a portion of a longitudinal length of said lift housing, and first and second retractable support arms that are connected to said main body and/or said housing.

9. The improved lifting device as defined in claim 8, wherein said main body optionally includes two or more main rollers or wheels that are configured to facilitate in moving said main housing over a floor, cargo bay or truck bed.

10. The improved lifting device as defined in claim 8, wherein said two or more main rollers or wheels are located below a top surface of said main housing.

11. The improved lifting device as defined in claim 8, wherein said fork structure is foldable and/or pivotable on said lift housing between a folded storable position and a unfolded operational position.

12. The improved lifting device as defined in claim 11, wherein a) a longitudinal axis of said fork structure in said folded storable position is oriented ±0-15° to a plane that is parallel to a front face plane of said lift housing, and/or b) wherein a) said longitudinal axis of said fork structure in said unfolded operational position is oriented ±0-15° to a plane that is perpendicular to said front face plane of said lift housing.

13. The improved lifting device as defined in claim 8, wherein said fork structure include one or more rollers or wheels to wheels to facilitate in a) moving of said fork structure over a floor, cargo bay, or truck bed when said fork structure is in said unfolded operational position, and/or b) positioning said fork structure under a load to be lifted by the fork structure.

14. The improved lifting device as defined in claim 8, wherein said retractable support arms are configured to move between a retract stored position and a nonretracted support position.

15. The improved lifting device as defined in claim 8, wherein each of said retractable support arms are rotatably or pivotally connected to said main body and/or lift housing.

16. The improved lifting device as defined in claim 8, wherein each of retractable support arms can be rotated about multiple axis during movement of each of said retractable support arms between said retract stored position and said nonretracted support position.

17. The improved lifting device as defined in claim 8, wherein said one or more roller or wheels on each of said retractable support arms can be pivotally or rotatably mounted so that said one or more roller or wheel can both roll and swivel relative to said retractable support arms.
